(19) United States
(12) Patent Application Publication
(10) Pub. No.: US 2020/0019189 A1
(43) Pub. Date: Jan. 16, 2020

(54) SYSTEMS AND METHODS FOR OPERATING UNMANNED AERIAL VEHICLE

(71) Applicant: SZ DJI TECHNOLOGY CO., LTD., Shenzhen (CN)

(72) Inventors: Chaobin CHEN, Shenzhen (CN); Guang YAN, Shenzhen (CN)

(21) Appl. No.: 16/562,051

(22) Filed: Sep. 5, 2019

Related U.S. Application Data
(63) Continuation of application No. PCT/CN2017/076020, filed on Mar. 9, 2017.

(51) Int. Cl. G05D 1/10; B64C 39/02

(52) U.S. Cl. CPC G05D 1/101; B64C 39/024; G05D 1/106; B64C 2201/141; B64C 2201/127; B64C 2201/027; B64C 2201/146

(57) ABSTRACT

An unmanned aerial vehicle (UAV) includes one or more propulsion units configured to generate lift to effect flight of the UAV, one or more receivers configured to receive user input from a remote controller, and one or more processors configured to: 1) permit the UAV to fly autonomously along a planned trajectory when no user input is received by the one or more receivers and 2) permit the UAV to fly completely based on the user input when the user input is received by the one or more receivers.

### CROSS-REFERENCE TO RELATED APPLICATION

This application is a continuation of International Application No. PCT/CN2017/076020, filed Mar. 9, 2017, the entire content of which is incorporated herein by reference.

### BACKGROUND OF THE DISCLOSURE

Unmanned vehicles, such as ground vehicles, aerial vehicles, surface vehicles, underwater vehicles, and spacecraft, have been developed for a wide range of applications including surveillance, search and rescue operations, exploration, and other fields. In some instances, unmanned vehicles may carry a payload configured to collect data during operation. For example, unmanned aerial vehicles (UAV) may be equipped with image capture devices, such as cameras, for aerial photography. A payload may be coupled to an unmanned vehicle via a carrier that provides movement of the payload in one or more degrees of freedom. Further, an unmanned vehicle may be outfitted with one or more functional units and components, such as various sensors for collecting different types of data from the surrounding environment. In some instances, a UAV may be able to fly in accordance with a preplanned path, for example, a flight trajectory planned by a user prior to the flight.

### SUMMARY OF THE DISCLOSURE

A need exists for improving usability, maneuverability, and controllability of vehicles, such as aerial vehicles, for example unmanned aerial vehicles (UAVs). The systems, methods, and devices described in this specification may enable the UAVs to efficiently and safely fly in the air in an autonomous mode or in a manually-controlled mode, or in a combination thereof (i.e., in a semi-autonomous mode). When operating in the autonomous mode, the UAV may be able to fly in the air on its own without any assistance from a user. When operating in the manually-controlled mode, the UAV may be controlled completely by an external device, e.g., a remote controller, which may perform, among other things, operations of receiving the user input, converting it into one or more flight control instructions, and transmitting these flight control instructions to the UAV, thereby controlling the flight of the UAV. When operating in the semi-autonomous mode, which seems to combine the autonomous mode with the manually-controlled mode, the UAV can be controlled by adding the control components from the remote controller to one or more autonomous control components generated solely by the UAV.

Depending on different application scenarios, settings or configurations, the UAV may be able to seamlessly switch among the autonomous mode, semi-autonomous mode and manually-controlled mode. The semi-autonomous node and manually-controlled mode herein may be collectively referred to as a user-intervened mode. For example, the UAV according to exemplary embodiments of the disclosure may be configured to automatically switch from the manually-controlled mode to the autonomous mode when no user input is received. Likewise, the UAV may be configured to automatically switch from the autonomous mode to the manually-controlled mode if a user input is received. Similar to the switch between the manually-controlled mode and autonomous mode, the UAV may also be configured to automatically switch between the autonomous mode and the semi-autonomous mode. For example, based on the user configuration upfront, upon receiving the user input, the UAV may automatically operate in the semi-autonomous mode and may automatically switch to operate in the autonomous mode when no user input is received or after the received user input is executed.

A UAV operating in one of the above autonomous mode, semi-autonomous mode, and manually-controlled manner can be scheduled to fly along a flight trajectory. The flight trajectory herein may be a planned trajectory which may be planned by a user prior to the flight. In some situations, the flight trajectory may be planned without regard to one or more possible obstacles present along the flight trajectory, thereby enhancing the freedom of planning a flight trajectory desired by the user. When flying along the planned trajectory, the UAV may be switched among these modes based on its own decision or a decision from the user via the remote controller. In some situations, the UAV may transmit a request signal to the user, requesting for its mode switching, for example, from an autonomous mode to a manually-controlled mode or to a semi-autonomous mode.

The flight trajectory or planned trajectory may be within an operational area. In some cases, the flight trajectory may be set within the already-prepared operational area. In some other cases, the flight trajectory may be obtained first and then the operational area may be configured to encompass the flight trajectory. The operational area may be generated in response to a user input. For example, the user input may be implemented via a user interface arranged on a remote controller, or via a user interface on a device in communication with the remote controller. The user can set or configure via the user interface one or more characteristics of the operational area by taking the planned trajectory in account. In some situations, an operational area may be generated in response to a detection of an obstacle present along the planed trajectory. The operational area generated in this way may encompass the detected obstacle. By means of the operational area as discussed in this specification, the UAV may be controlled differently based on different control rules when it is in the operational area and not in the operational area, i.e., outside of the operational area, thereby improving the maneuverability and controllability of the UAV.

An aspect of the disclosure is directed to an unmanned aerial vehicle (UAV), said UAV comprising: one or more propulsion units configured to generate lift to effect flight of the UAV; one or more receivers configured to receive user input from a remote controller; and one or more processors configured to: 1) permit the UAV to fly autonomously along a planned trajectory when no user input is received by the one or more receivers and 2) permit the UAV to fly completely based on the user input when the user input is received by the one or more receivers.

Another aspect of the disclosure is directed to a method for controlling flight of an unmanned aerial vehicle (UAV), said method comprising: effecting a flight of the UAV, with aid of one or more propulsion units, along a planned trajectory; permitting, with aid of one or more processors, the UAV to: 1) fly autonomously along the planned trajectory when no user input is received by one or more receivers of the UAV, and 2) fly completely based on the user input when the user input is received by the one or more receivers of the UAV.

An additional aspect of the disclosure is directed to a remote controller for controlling operation of an unmanned aerial vehicle (UAV), said remote controller comprising: a user interface configured to receive user input from a user; and a communication unit configured to transmit, while the UAV is in an autonomous flight along a planned trajectory, an instruction for the UAV to fly completely based on the user input, wherein the UAV is configured to fly autonomously along the planed trajectory when no user input is received.

A method for controlling operation of an unmanned aerial vehicle (UAV) is provided in a further aspect of the disclosure, said method comprising: receiving user input from a user; and transmitting, while the UAV is in an autonomous flight along a planned trajectory, an instruction for the UAV to fly completely based on the user input, wherein the UAV is configured to fly autonomously along the planned trajectory when no user input is received.

In some embodiments, the planned trajectory is planned prior to flight of the UAV without regard to presence of one or more obstacles along the planned trajectory.

In some embodiments, the planned trajectory is changed by the user input such that the UAV is permitted to fly autonomously along the changed planned trajectory.

In some embodiments, the planned trajectory is a three dimensional flight trajectory.

In some embodiments, the one or more processors are further configured to permit the UAV to continue with the autonomous flight along the planned trajectory after the user input is executed.

In some embodiments, the one or more processors are configured to permit the UAV to deviate from the planned trajectory based on the user input.

In some embodiments, the one or more processors are further configured to permit the UAV to deviate from the planned trajectory to avoid one or more obstacles present along the planned trajectory.

In some embodiments, the one or more processors are further configured to permit the UAV to autonomously return back to the planned trajectory.

In some embodiments, the flight of the UAV back to the planned trajectory comprises a progressively smooth flight back to the planned trajectory along a curved path intersecting with the planned trajectory.

In some embodiments, the flight of the UAV back to the planned trajectory is along a shortest path intersecting with the planned trajectory.

In some embodiments, the flight of the UAV back to the planned trajectory is along a path specified by a user.

In some embodiments, the UAV comprises one or more transmitters configured to transmit a request signal to the remote controller for requiring the user input.

In some embodiments, the request signal is transmitted upon detecting one or more obstacles present along the planned trajectory.

In some embodiments, the request signal is transmitted based on operational information collected by one or more sensors on-board the UAV.

In some embodiments, the one or more processors are configured to permit the UAV to return back to the autonomous flight when no user input is received within a period of time.

In some embodiments, the period of time is set in advance by a user via the remote controller.

In some embodiments, the one or more processors are configured to permit the UAV to neglect flight operations associated with the autonomous flight while flying completely based on the user input.

In some embodiments, the user input is implemented by a user interface arranged on the remote controller.

In some embodiments, the user interface comprises one or more control sticks for receiving the user input.

In some embodiments, the user input comprises one or more instructions for changing one or more flight parameters of the UAV.

In some embodiments, the one or more flight parameters comprise one or more of a flight direction, a flight orientation, a flight height, a flight speed, acceleration, or a combination thereof.

In some embodiments, the one or more processors may be configured to permit the UAV to switch between an autonomous flight and a manually-controlled flight based on whether the use input is received.

An aspect of the disclosure is directed to an unmanned aerial vehicle (UAV), said UAV comprising: one or more propulsion units configured to generate lift to effect flight of the UAV; one or more processors, configured to: obtain an indication of whether a UAV is flying within an operational area, and generate one or more flight control signals to cause the UAV to fly (1) in accordance with a first set of control rules, when the UAV is within the operational area, and (2) in accordance with a second set of control rules different from the first set of control rules, when the UAV is outside the operational area, wherein the operational area is defined with respect to a flight trajectory.

A further aspect of the disclosure is directed to a method for controlling flight of an unmanned aerial vehicle (UAV), said method comprising: detecting whether a UAV is flying within an operational area; and effecting a flight of the UAV, with aid of one or more propulsion units, (1) in accordance with a first set of control rules, when the UAV is within the operational area, and (2) in accordance with a second set of control rules different from the first set of control rules, when the UAV is outside the operational area, wherein the operational area is defined with respect to a flight trajectory.

A remote controller for controlling operation of an unmanned aerial vehicle (UAV) is provided in an additional aspect of the disclosure, the remote controller comprising: a user interface configured to receive user input from a user; and a communication unit configured to transmit, while the UAV is in flight, an instruction for the UAV to fly based on the user input with aid of one or more propulsion units, wherein the user input effects (1) flight of the UAV in accordance with a first set of control rules, when the UAV is within an operational area, and (2) flight of the UAV in accordance with a second set of control rules different from the first set of control rules, when the UAV is outside the operational area, wherein the operational area is defined with respect to a flight trajectory.

An aspect of the disclosure is directed to a method for controlling operation of an unmanned aerial vehicle (UAV), said method comprising: receiving user input from a user; transmitting, while the UAV is in flight, an instruction for the UAV to fly based on the user input with aid of one or more propulsion units, wherein the user input effects (1) flight of the UAV in accordance with a first set of control rules, when the UAV is within an operational area, and (2) flight of the UAV in accordance with a second set of control rules different from the first set of control rules, when the UAV is outside the operational area, wherein the operational area is defined with respect to a flight trajectory.

In some embodiments, the flight of the UAV is following the flight trajectory in accordance with the first set of control rules, when the UAV is within the operational area.

In some embodiments, the flight of the UAV following the flight trajectory is based at least in part on one of a plurality of conditions.

In some embodiments, the plurality of conditions include one or more of absence of an obstacle along the flight trajectory, absence of an undesirable environmental factor within the operational area, and absence of a restricted area within the operational area.

In some embodiments, the flight of the UAV is effected autonomously in accordance with the first set of control rules, when the UAV is within the operational area.

In some embodiments, the flight of the UAV is controlled by a user via a remote controller for assisting the autonomous flight of the UAV, in accordance with the first set of control rules.

In some embodiments, the flight of the UAV is effected autonomously by following the flight trajectory in accordance with the first set of control rules.

In some embodiments, the flight of the UAV is configured to switch between an autonomous flight and a user-intervened flight based on whether the user input is received.

In some embodiments, the flight of the UAV is controlled by a user via a remote controller in accordance with the second set of control rules, when the UAV is outside the operational area.

In some embodiments, the flight of the UAV is effected manually by a user via a remote controller, in accordance with the first set of control rules, when the UAV is within the operational area.

In some embodiments, the flight of the UAV is configured to switch between an autonomous flight and a user-intervened flight based on whether the user input is received, when the UAV is within the operational area.

In some embodiments, the flight of the UAV is effected autonomously in accordance with the second set of control rules, when the UAV is outside the operational area.

In some embodiments, the flight of the UAV is effected by a combination of autonomous flight and the user input in accordance with the second set of control rules, when the UAV is outside the operational area.

In some embodiments, a flight path is automatically generated for guiding the UAV outside the operational area to fly back to the flight trajectory, in accordance with the second set of control rules.

In some embodiments, the UAV is configured to deviate from the flight trajectory within the operational area in accordance with the first set of control rules.

In some embodiments, the flight of the UAV back to the flight trajectory comprises a progressively smooth flight back to the flight trajectory along a curved path intersecting with the flight trajectory.

In some embodiments, the flight of the UAV back to the flight trajectory is along a shortest path intersecting with the flight trajectory.

In some embodiments, the flight of the UAV back to the flight trajectory is along a path specified by a user via a remote controller capable of remotely controlling the UAV.

In some embodiments, the detection of whether the UAV is flying within the operational area is performed in accordance with at least one of the first set of control rules and the second set of control rules.

In some embodiments, the operational area is generated in response to a detection of an obstacle along the flight trajectory followed by the UAV and the operational area encompasses the obstacle.

In some embodiments, the operational area is generated in response to user input.

In some embodiments, the flight trajectory is configured to be within the operational area.

In some embodiments, the flight trajectory is planned without regard to presence of one or more obstacles along the flight trajectory.

In some embodiments, the flight trajectory includes a plurality of trajectory segments and the operational area includes a plurality of subareas, each of the plurality of trajectory segments being associated with a corresponding one of the plurality of subareas.

In some embodiments, one or more parameters of the operational area are configured to form a three dimensional spatial space.

In some embodiments, the operational area is generated as an area with fully enclosed or partially enclosed boundaries.

In some embodiments, the operational area is a cylinder and the flight trajectory is a central axis of the cylinder.

In some embodiments, the one or more parameters of the operational area are configured by a software development kit on-board the UAV or off-board the UAV.

In some embodiments, the one or more parameters comprise one or more geometric characteristics.

In some embodiments, the one or more parameters are configured by a user interface with a plurality of options corresponding to the one or more parameters.

In some embodiments, the user interface is arranged on the UAV or on the remote controller capable of remotely controlling the UAV.

In some embodiments, the operational area remains unchanged during the flight of the UAV along the flight trajectory in accordance with the first set of control rules.

In some embodiments, the operational area is changed during the flight of the UAV along the flight trajectory in accordance with the first set of control rules.

In some embodiments, a size and/or a shape of the operational area is changed during the flight of the UAV along the flight trajectory.

In some embodiments, the operational area is changed in response to user input from a user via a remote controller.

In some embodiments, the UAV is configured to check its proximity to the operational area when the UAV is outside the operational area.

In some embodiments, the UAV is configured to determine its distance to the operational area based on the proximity.

In some embodiments, the UAV is configured to determine whether it is within the operational area based on the proximity.

In some embodiments, the UAV is configured to transmit a signal indicative of the proximity to a remote controller capable of remotely controlling the UAV.

In some embodiments, the UAV is configured to cease a flight task associated with a flight trajectory when the UAV is outside the operational area.

In some embodiments, the operational area is changed when the UAV is outside the operational area such that the UAV's flight is within the changed operational area.

In some embodiments, the operational area is changed with aid of one or more processors on-board the UAV.

In some embodiments, the operational area is changed based on user input from a user via a remote controller capable of remotely controlling the UAV.

In some embodiments, whether the UAV enters into the operational area or exits from the operational area is determined by a user via a remote controller capable of remotely controlling the UAV.

In some embodiments, a user interface is arranged on a remote controller for reminding a user of entry of the UAV into the operational area and/or exit of the UAV from the operational area.

In some embodiments, the one or more processors are configured to generate the one or more flight control signals to cause the UAV to fly back to the operational area from outside the operational area.

In some embodiments, the flight of the UAV back to the operational area is effected by user input from a user via a remote controller capable of remotely controlling the UAV.

In some embodiments, the flight of the UAV back to the operational area is effected with aid of one or more sensors on-board the UAV.

Another aspect of the disclosure is directed to an unmanned aerial vehicle (UAV), said UAV comprising: one or more propulsion units configured to generate lift to effect flight of the UAV; one or more receivers configured to receive user input from a remote controller; and one or more processors configured to: 1) permit the UAV to fly completely based on the user input when the user input is received by the one or more receivers, and (2) permit the UAV to fly based on one or more autonomous flight instructions generated on-board the UAV or a combination of the user input and the one or more autonomous flight instructions, when one or more conditions are met.

A further aspect of the disclosure is directed to a method for controlling flight of an unmanned aerial vehicle (UAV), said method comprising: receiving user input from a remote controller; and effecting a flight of the UAV with aid of one or more propulsion units, wherein the UAV is permitted to (1) fly completely based on the user input when the user input is received, and (2) fly based on one or more autonomous flight instructions generated on-board the UAV or a combination of the user input and the one or more autonomous flight instructions, when one or more conditions are met.

A remote controller for controlling operation of an unmanned aerial vehicle (UAV) is provided in another aspect of the disclosure, said remote controller comprising: a user interface configured to receive user input from a user; and a communication unit configured to transmit the user input to the UAV, such that the UAV is permitted to: (1) fly completely based on the user input when the user input is received by the UAV, and (2) fly based on a combination of the user input and one or more autonomous flight instructions generated on-board the UAV, when one or more conditions are met.

Another aspect of the disclosure is directed to a method for controlling operation of an unmanned aerial vehicle (UAV), said method comprising receiving user input from a user; transmitting the user input to the UAV, such that the UAV is permitted to: (1) fly completely based on the user input when the user input is received by the UAV, and (2) fly based on a combination of the user input and one or more autonomous flight instructions generated on-board the UAV, when one or more conditions are met.

In some embodiments, the one or more conditions comprise presence or absence of the UAV within an operational area.

In some embodiments, the operational area is defined with respect to a flight trajectory followed by the UAV in the autonomous flight.

In some embodiments, one or more parameters of the operational area are determined in response to the user input when planning the flight trajectory of the UAV.

In some embodiments, the flight trajectory is configured to be within the operational area.

In some embodiments, the operational area is generated in response to user input.

In some embodiments, the communication unit is further configured to transmit the user input to the UAV such that the UAV is permitted to fly based on the one or more autonomous flight instructions or based on a combination of the user input and the one or more autonomous flight instructions, when the UAV is within the operational area.

In some embodiments, the flight of the UAV is configured to switch between an autonomous flight and a semi-autonomous flight based on whether the user input is received, when the UAV is within the operational area, wherein the semi-autonomous flight is based on a combination of the user input and the one or more autonomous flight instructions.

In some embodiments, the communication unit is further configured to transmit the user input to the UAV such that the UAV is permitted to fly completely based on the user input when the UAV is outside the operational area.

In some embodiments, the operational area is generated in response to a detection of an obstacle along the flight trajectory followed by the UAV and the operational area encompasses the obstacle

In some embodiments, the communication unit is further configured to transmit the user input to the UAV such that the UAV is permitted to fly completely based on the user input when the UAV is within the operational area.

In some embodiments, the communication unit is further configured to transmit the user input to the UAV such that the UAV is permitted to fly based on a combination of the user input and the one or more autonomous flight instructions when the UAV is outside the operational area.

In some embodiments, the one or more conditions comprise a flight state of the UAV.

In some embodiments, the flight state of the UAV comprises one or more of states of one or more propulsion units, states of one or more battery units, states of one or more onboard sensors, states of one or more carriers supported by the UAV, states of one or more payloads coupled to the UAV.

In some embodiments, a flight safety level is obtained based on the flight state of the UAV.

In some embodiments, the communication unit is further configured to transmit the user input to the UAV such that the UAV is permitted to fly based on the user input and the one or more autonomous flight instructions, when the flight safety level indicates that the use input is not needed for the flight of the UAV.

In some embodiments, the communication unit is further configured to transmit the user input to the UAV such that the UAV is permitted to fly completely based on the user input, when the flight safety level indicates that the user input is needed for the flight of the UAV.

In some embodiments, the user input comprises one or more control components generated via the remote controller.

In some embodiments, the remote controller comprises one or more actuatable mechanisms for generating the one or more control components.

In some embodiments, the one or more actuatable mechanisms comprise one or more control sticks.

In some embodiments, an actuation of the one or more control sticks is configured to generate the one or more control components.

In some embodiments, the one or more control components comprise one or more of a velocity component, a direction component, a rotation component, an acceleration component, or a combination thereof.

In some embodiments, the combination of the user input and the one or more autonomous flight instructions comprises adding the one or more control components generated by the actuation of the one or more control sticks to one or more corresponding autonomous control components in the autonomous flight instructions.

It shall be understood that different aspects of the disclosure may be appreciated individually, collectively, or in combination with each other. Various aspects of the disclosure described herein may be applied to any of the particular applications set forth below or for any other types of movable objects. Any description herein of an aerial vehicle may apply to and be used for any movable object, such as any vehicle. Additionally, the apparatuses and methods disclosed herein in the context of aerial motion (e.g., flight) may also be applied in the context of other types of motion, such as movement on the ground or on water, underwater motion, or motion in space.

Other objects and features of the disclosure will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference in its entirety.

### BRIEF DESCRIPTION OF THE DRAWINGS

The novel features of the invention are set forth with particularity in the appended claims. A better understanding of the features and advantages of the disclosure will be obtained by reference to the following detailed description that sets forth illustrative embodiments, in which the principles of the disclosure are utilized, and the accompanying drawings of which:

FIG. 1 shows a schematic view of an unmanned aerial vehicle (UAV) and a remote controller, in accordance with embodiments of the disclosure.

FIG. 2 shows a schematic view of UAVs flying along different planned trajectories, in accordance with embodiments of the disclosure.

FIG. 3 shows a schematic view of a UAV flying back to a planned trajectory via different paths, in accordance with embodiments of the disclosure.

FIG. 4 shows a schematic view of a UAV operating in a manually-controlled mode via a remote controller, in accordance with embodiments of the disclosure.

FIG. 5 shows a flow chart of a method for controlling flight of a UAV, in accordance with embodiments of the disclosure.

FIG. 6 shows schematic views of UAVs flying in different operational areas, in accordance with embodiments of the disclosure.

FIG. 7 shows schematic views of UAVs flying in an operational area and a non-operational area, in accordance with embodiments of the disclosure.

FIG. 8 shows a flow chart of a method for controlling flight of a UAV, in accordance with embodiments of the disclosure.

FIG. 9 provides an illustration of an autonomous flight of a UAV with or without manual control, in accordance with embodiments of the disclosure.

FIG. 10 shows a flow chart of a method for controlling operation of a UAV, in accordance with embodiments of the disclosure.

FIG. 11 illustrates a movable object in accordance with embodiments of the disclosure.

FIG. 12 illustrates a system for controlling a movable object, in accordance with embodiments of the disclosure.

### DETAILED DESCRIPTION OF THE EMBODIMENTS

Systems, devices and methods are provided for controlling flight or operation of an unmanned aerial vehicle (UAV). The UAV may, among other things, comprise one or more propulsion units configured to generate lift to effect flight of the UAV. The UAV may be capable of flying autonomously based on on-board processor(s) without needing any control or assistance from outside. The UAV may also comprise one or more receivers configured to receive one or more external instructions or signals. The external instructions may be user input from a user, e.g., a remote user who is distant from the UAV. The user input may be implemented by a remote controller capable of remotely controlling the UAV. Thereby, the UAV may be capable of flying in a non-autonomous mode (e.g., a manually-controlled mode or a semi-autonomous mode) based on the user input. Any description herein of a UAV may apply to any type of aerial vehicle or movable object, or vice versa.

The UAV discussed in this specification may comprise one or more processors configured to permit autonomous flight of the UAV when no user input is received by the one or more receivers. The autonomous flight herein may include autonomous return of the UAV, autonomous navigation of the UAV along one or more waypoints, autonomous flight of the UAV along a planned trajectory, and/or autonomous flight of the UAV to a point of interest. The planned trajectory may be a flight trajectory planned by the user prior to the flight of the UAV without regard to presence of one or more obstacles along the planned trajectory. Thereby, the user may be able to plan a shortest path or a customized path for the flight of the UAV. The planned trajectory may be changed during the flight by the UAV itself. In some situations, the planned trajectory may be changed by the user input received by the UAV and then the UAV may continue its autonomous flight along the changed or updated trajectory. The change of the planned trajectory may be triggered by one or more conditions. As an example, the planned trajectory may be changed due to the presence of one or more obstacles along the planned trajectory.

In some instances, the one or more processors may be configured to permit the UAV to fly completely based on the user input when the user input is received by the one or more receivers. In this case, the UAV may neglect or ignore autonomous flight instructions generated on-board the UAV and merely rely upon the user input received from the remote controller to fly. In other words, the user input may be configured to have a higher priority over the autonomous flight instructions in terms of UAV controlling. Optionally, the user input may have a higher priority over the autonomous flight in certain selected sets of circumstances. The autonomous flight may optionally have higher priority over the user input in certain selected sets of circumstances. In some examples, responsive to receiving the user input from the user, the UAV may immediately cease or exit from the autonomous flight and start non-autonomous flight based on the user input. For example, the user input may be used to guide the UAV to avoid an obstacle present along the planned trajectory, thereby significantly reducing the likelihood of the UVA colliding with the obstacle. Additionally or alternatively, the user input may be used to assist the UAV in flying along the planned trajectory. For example, the user input may change the flight speed of the UAV or orientation of the UAV during the flight. Further, the user input may change a direction of flight of the UAV during the flight.

The user input may be implemented by an external device, for example, a remote controller capable of remotely controlling the UAV. Alternatively, the user input may be implemented by an external device, for example, a display device that connects to the remote controller and controls the UAV via the remote controller. The remote controller may comprise a user interface configured to receive user input from the user. For example, the user interface may be embodied as a display device with a touch sensitive display for receiving user touch as a form of the user input. The remote controller may also comprise a communication unit configured to transmit an instruction for the UAV to fly completely based on the user input. For example, while the UAV is in an autonomous flight along a planned trajectory, the communication unit may be configured to transmit an instruction for the UAV to fly completely based on the user input. Upon receipt of such an instruction, the UAV may cease the autonomous flight and manually-controlled flight may commence.

To achieve a better performance during the flight of the UAV, an operational area may be established such that the UAV may fly in accordance with multiple sets of control rules, depending on whether it is within the operational area. In some instances, the multiple control rules may comprise a first set of control rules and a second set of control rules different from the first set of control rules. Thereby, the UAV may be configured to fly in accordance with the first set of control rules when the UAV is within the operational area and may be configured to fly in accordance with the second set of control rules when the UAV is outside the operational area. In this manner, the controllability and maneuverability of the UAV may be enhanced since diversified controlling operations may be accomplished in view of the location of the UAV relative to the operational area. For example, the one or more processors may obtain an indication signal indicative of whether the UAV is within the operational area. With aid of the indication signal, the one or more processors may instruct the UAV to fly in accordance with one of the first and second sets of control rules.

The flight of the UAV in accordance with the first or second set of control rules may be effected with aid of user input from a user. The user input discussed herein or elsewhere in this specification may be implemented by a remote controller capable of remotely controlling the UAV. The remote controller may comprise a user interface configured to receive the user input and a communication unit configured to transmit the user input or an instruction, which may be converted from the user input, to the UAV. Depending on whether the user input is received, the UAV may fly in accordance with the first set of control rules when the UAV is within the operational area or may fly in accordance with the second set of control rules when the UAV is outside the operational area. In some embodiments, the operational area may be defined with respect to a flight trajectory. The flight trajectory herein may be the planned trajectory as mentioned before. The flight trajectory may be configured or planned within the operational area.

In some instances, one or more processors of a UAV may be configured to permit the UAV to fly completely based on the received user input when one or more conditions are met. Additionally, the one or more processors of the UAV may be configured to permit the UAV to fly based on one or more autonomous flight instructions generated on-board the UAV when or more conditions are met. In some instances, the one or more processors of the UAV may be configured to permit the UAV to fly based on a combination of the received user input and the one or more autonomous flight instructions. The one or more conditions herein may comprise presence or absence of the UAV within an operational area, which is the same as the one mentioned before. Alternatively, the one or more conditions may comprise a flight state of the UAV from which a flight safety level is obtained. In this manner, the user control of the UAV may be more accurate and selective and flight safety of the UAV may be further improved.

It shall be understood that different aspects of the disclosure can be appreciated individually, collectively, or in combination with each other. Various aspects of the disclosure described herein may be applied to any of the particular applications set forth below or for any other types of remotely controlled vehicles or movable objects.

Various embodiments of the disclosure will be described in detail below with reference to the accompanying drawings.

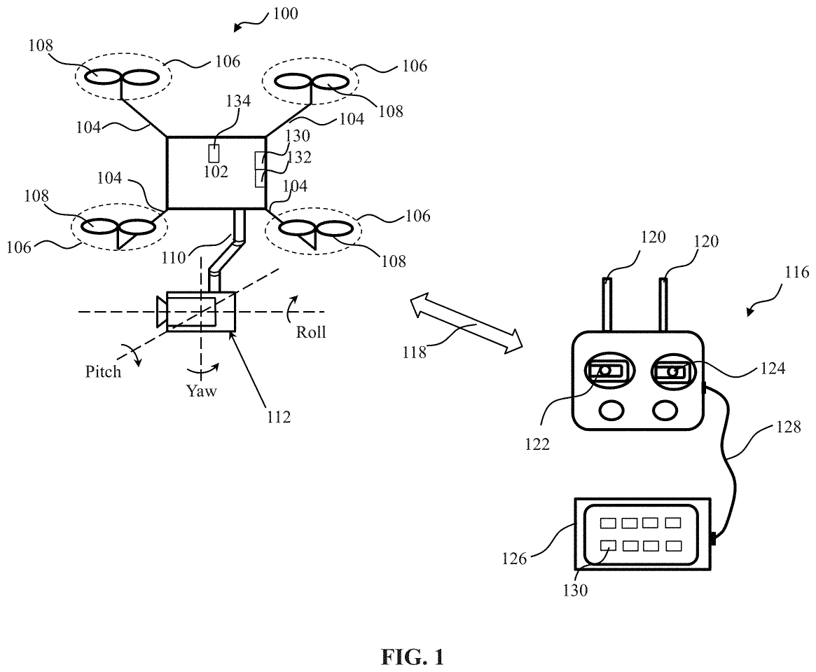

FIG. 1 shows a schematic view of an unmanned aerial vehicle (UAV) 100 and a remote controller 116, in accordance with embodiments of the disclosure. Any description herein of a UAV may apply to any type of movable object and vice versa. Any description herein of a UAV may apply to any type of aerial vehicle, or unmanned vehicle. The moveable object may be a motorized vehicle or vessel having one or more fixed or movable arms, wings, extended sections, and/or propulsion units. The UAV may be a multi-rotor UAV.

As illustrated at a left part of FIG. 1, a UAV 100 may include a UAV body 102. The UAV body may be a central body. The UAV body may be formed from a solid piece. Alternatively, the UAV body may be hollow or may include one or more cavities therein. The UAV body may have any shape and size. For example, a shape of the UAV body may be rectangular, prismatic, spherical, ellipsoidal, or the like. The UAV may have a substantially disc-like shape in some embodiments. A center of gravity of a UAV may be within a UAV body, above a UAV body, or below a UAV body. A center of gravity of a UAV may pass through an axis extending vertically through the UAV body.

A UAV body may include a housing that may partially or completely enclose one or more components therein. The components may include one or more electrical components. Examples of components may include, but are not limited to, a flight controller, one or more processors, one or more memory storage units, a communication unit, a display, a navigation unit, one or more sensors, a power supply and/or control unit, one or more electronic speed control (ESC) modules, one or more inertial measurement units (IMUs) or any other components.

A UAV body may support one or more arms 104 of the UAV extendable from the UAV body. The UAV body may bear weight of the one or more arms. The UAV body may directly contact one or more arms. The UAV body may be integrally formed with the one or more arms or components of one or more arms. The UAV may connect to the one or more arms via one or more intermediary pieces. The UAV may have any number of arms. For example, the UAV can have one, two, three, four, five, six, seven, eight, nine, ten, or more than ten arms. The arms may optionally extend radially from the central body. The arms may be arranged symmetrically about a plane intersecting the central body of the UAV. Alternatively, the arms may be arranged symmetrically in a radial fashion.

Various components as described above may also be disposed on, within, or embedded in an arm of the UAV. The arms may optionally include one or more cavities that may house one or more of the components (e.g., electrical components). In one example, the arms may or may not have inertial sensors that may provide information about a position (e.g., orientation, spatial location) or movement of the arms.

One or more of the arms may be static relative to the central body, or may be movable relative to the central body. The plurality of arms as shown may be fixedly or rotatably coupled to the central body via a plurality of joints (not shown). The joints may be located at or near the perimeter of the central body. Optionally, the joints may be located on the sides or edges of the central body. The plurality of joints may be configured to permit the arms to rotate relative to one, two or more rotational axes. The rotational axes may be parallel, orthogonal, or oblique to one another. The plurality of rotational axes may also be parallel, orthogonal, or oblique to one or more of a roll axis, a pitch axis, and a yaw axis of the UAV.

The plurality of arms may support one or more propulsion units 106 carrying one or more rotor blades 108. In some embodiments, each arm may comprise a single propulsion unit or multiple propulsion units. The rotor blades may be actuated by a motor or an engine to generate a lift force for the UAV. For example, the rotor blades may be affixed to a rotor of a motor such that the rotor blades rotate with the rotor to generate a lift force (thrust). The UAV may be capable of self-propulsion with aid of the one or more propulsion units. For example, as the rotation of the rotor blades carried by the propulsion units, the thrust forces may be generated for lifting the UAV upward. During the flight of the UAV, one or more propulsion units may receive, from one or more flight controller systems on-board the UAV, one or more control signals to effect corresponding operations. For example, based on the speed control with aid of a speed controller embedded in a central body of the UAV, the rotor blades may rotate at the same or different rotational speeds, thereby the UAV flying around in the air as an aerial vehicle.

The UAV may support one or more carriers 110, such as a gimbal that holds a payload of the UAV. The gimbal may be permanently affixed to the UAV or may be removably attached to the UAV. The gimbal may include one or more gimbal components that may be movable relative to one another. The gimbal components may rotate about one or more axes relative to one another. The gimbal may include one or more actuators that effect rotation of the one or more gimbal components relative to one another. The actuators may be motors. The actuators may permit rotation in a clockwise and/or counter-clockwise direction. The actuators may or may not provide feedback signals as to the position or movement of the actuators. In some instances, one or more gimbal components may support or bear the weight of additional gimbal components. In some instances, gimbal components may permit rotation of a payload about a pitch, yaw, and/or roll axis as shown. A gimbal component may permit rotation about a pitch axis, another gimbal component may permit rotation about a yaw axis, and another gimbal component may permit rotation about a roll axis. For example, a first gimbal component can bear weight of a camera and rotate about the pitch axis, a second gimbal component can bear weight of the first gimbal component and/or payload (e.g., the camera) and rotate about the roll axis, and a third gimbal component can bear weight of the first and second gimbal components and/or payload and rotate about the yaw axis. The axes may be relative to a payload carried by the carrier and/or the UAV.

The gimbal may support a payload. The payload may be permanently affixed to the gimbal or may be removably attached to a gimbal. The payload may be supported by a gimbal component. The payload may be directed connected to the gimbal component. The payload may remain at a fixed position relative to the gimbal component. Alternatively, the payload may rotate relative to the gimbal component. A payload may be an external sensor, for example a camera unit including an image capture device 112. The image capture device may be movable independent of the motion of the UAV. The image capture device may be movable relative to the UAV with aid of the gimbal. The UAV may be capable of capturing images using an image capture device while in flight. The UAV may be capable of capturing images using the image capture device while the UAV is landed on a surface. An image capture device, such as a camera, may have various adjustable parameters that may be adjusted by user input. The adjustable parameters may include but are not limited to exposure (e.g., exposure time, shutter speed, aperture, film speed), gain, gamma, area of interest, binning/subsampling, pixel clock, offset, triggering, ISO, image capture modes (e.g., video, photo, panoramic, night time mode, action mode, etc.), image viewing modes, image filters, etc. Parameters related to exposure may control the amount of light that reaches an image sensor in the image capture device. For example, shutter speed may control the amount of time light reaches an image sensor and aperture may control the amount of light that reaches the image sensor in a given time. Parameters related to gain may control the amplification of a signal from the optical sensor. ISO may control the level of sensitivity of the camera to available light.

Similar to the propulsion units, during the flight of the UAV, a carrier, payload, sensor, and/or other component of the UAV may receive, from one or more control systems on-board the UAV, a variety of control signals which may cause corresponding operations directed to the carrier, payload, sensor, and/or other component. With aid of the control signals generated independently by the UAV, the UAV may be capable of autonomous flight without any manual intervention during the flight. For example, after taking off from the ground, the UAV may autonomously fly along a planned trajectory and may perform autonomous obstacle avoidance if necessary without any manual intervention.

In some instances, a UAV may fly autonomously along a planned trajectory or just autonomously within the environment without following the planned trajectory. A planned trajectory may be determined by the UAV itself (e.g., generated by processor(s) of the UAV), or determined by an external device (e.g., processor(s) of a server, etc.), or planned by a user. A planned trajectory may be planned prior to takeoff of the UAV, prior to the flight of the UAV, or may be planned during the flight or after the takeoff of UAV. In some embodiments, an existing planned trajectory can be altered, changed or updated. The changes to the existing planned trajectory may occur prior to the flight or during the flight. In some implementations, the planned trajectory may be updated ahead of time, for example in a non-real-time manner.

In order for communication with an external system capable of remotely controlling the UAV, the UAV may also comprise one or more transmitters 130 or receivers 132, which may be collectively referred to as a transceiver. The transmitter may be configured to transmit various types of data or instructions to the external system, such as ambient data, sensed data, operating data and flight instructions. The receiver may be configured to receive user instructions from the external system. Further, the UAV may have one or more processors 134. The one or more processors herein may be general-purpose processors or dedicated processors. The one or more processors may be configured to permit the UAV to fly and carry out various operations, such as flying in one of an autonomous mode, a semi-autonomous mode or a manually-controlled mode. Further, the one or more processors may be configured to permit the UAV to perform obstacle avoidance with or without user input. It should be understood that the transmitters, receivers, and processors are illustrated within the UAV body merely for a clarity purpose, a person skilled in the art that they can be flexibly arranged at any locations of the UAV, such as on or within the arms.

The external system as mentioned above may include various types of external devices, external systems, or ground stations, which can remotely control the UAV and may be coupled to movable objects in some implementations. As an example, the external system may be a remote controller 116. The remote controller may be used to control one or more motion characteristics of a movable object (e.g., a UAV) and/or a payload (e.g., a carrier possibly supporting an image capture device). For example, the remote controller may be used to control the movable object such that the movable object is able to navigate to a target area, for example, from a takeoff site to a landing site. The remote controller may be used to give the instructions or commands that are transmitted to the UAV (e.g., a flight controller of the UAV) that effects flight of the UAV, as further described hereinafter. In some instances, the remote controller may be used to manually control the UAV and/or modify parameters of the UAV while the UAV is autonomously operating.

The manual control as mentioned above or discussed elsewhere in the specification may relate to controlling the UAV by user input. In some instances, the UAV may move exactly as the user input is given. As an example, by moving control sticks on the remote controller up or down, the elevation of the UAV will be changed accordingly, for example, pushing the control stick up to ascend and down to descend. The more the control sticks are moved away from its neutral position, the faster the UAV will change the elevation. As another example, by moving the control sticks on the remote controller to the left or right, the UAV will be rotated counter-clockwise or clockwise accordingly. The more the control sticks is pushed away from its neutral position, the faster the UAV will rotate. In some instances, an effect of the manual control may be resulted from a combo of the user input plus previous action by the UAV. For example, if the UAV is flying forward and the control stick is moved to a given direction, the UAV may veer to this given direction while still moving forward. Alternatively, the UAV may just stop moving forward and turn to the given direction, etc.

The transmissions between the remote controller and the UAV may be established via a communication link 118. The communication link herein may be a wired link or a wireless link. In some instances, a wired link may be established via any suitable wired communication technique (e.g., various wired interfaces) between the remote controller and the UAV for purposes of checking, debugging, simulation, or data transfer and the like. For example, a user may connect the remote controller to the UAV via a wired interface, such as a universal serial bus (USB) interface, to transfer mass of image data between the remote controller and the UAV. In some instances, a wireless link may be established via any suitable wireless communication technique (e.g., a cellular connection, a wireless local network connection, or a short range communication connection) between the remote controller and UAV, such that user input including various user instructions received by the remote controller can be wirelessly transmitted to the UAV. To this end, the remote controller may comprise one or more transmitters and receivers, or alternatively, transceivers, to implement two-way communication with the UAV via one or more antennas 120. To implement the wireless communication, the UAV and remote controller may be configured to be assigned some wireless resources (such as, frequency bands, time slots, and codes) according to the corresponding wireless communication protocols at the outset of the two-way communication. Then, the UAV and remote controller may transmit various types of the data therebetween on the assigned wireless resources, such as sensed data, captured image data, and operating data.

To receive user input for remotely controlling a UAV, a remote controller may comprise a user interface for user interaction with the UAV. The user interface may comprise one or more of a button, a switch, a dial, a touchscreen, a slider, a knob, a stick (e.g., joystick or control stick) or a key. The user interface, when embodied as a touch sensitive screen, may comprise a number of graphic objects or options for controlling and setting the remote controller or UAV as discussed above or elsewhere in this specification. A touchscreen may show a user interface that may permit user interaction with the screen. The touchscreen may be a source of input device and output device normally layered on the top of a display device. A user can give user input through simple or multi-touch gestures by touching the touch screen with a special stylus and/or one or more fingers. The touchscreen may enable the user to interact directly with the UAV, rather than using a mouse, touchpad, or any other intermediate device (other than a stylus).

In some implementations, different graphic objects may be displayed when the UAV is in an autonomous mode, a semi-autonomous mode and/or a manually-controlled mode. In some implementations, all the graphic objects may be displayed on the screen regardless of the mode or state of the UAV. In some instances, different setting or control pages for different purposes may be displayed on the screen and the user may search a desired page via the touching or swiping of a finger. For example, a setting page may comprise one or more options or items for planning a flight trajectory or an operational area, as will be discussed in detail later. In some embodiments, the user interface may comprise graphic objects for controlling a carrier (e.g., a gimbal) such that an image capture device coupled to the gimbal is driven to rotate about one or more axes relative to the UAV.

Additionally or alternatively, the user interface as discussed above may be implemented as or on a separate device 126, e.g., a display device, such as a pad, a tablet, a personal digital assistant, a mobile phone, or the like. The device may be connected to the remote controller via a wired connection 128 (e.g., a USB connection). Alternatively, the device may be connected to the remote controller via a wireless connection (e.g., a cellular or a Bluetooth connection). In an example where the device has a touch sensitive display, one or more graphic objects 130 similar to those as discussed above may be displayed on the display for user selection. By touching or swiping on the touch sensitive display, the user input may be received by the separate device and transmitted to the remote controller, via which, the user input may be converted or transformed into one or more user instructions and transmitted wirelessly to the UAV for execution.

As an example, the remote controller as discussed herein or elsewhere in the specification may comprise one or more control sticks 122 and 124. The control sticks may be configured to affect rotation of a UAV about one or more axes. For example, the one or more control sticks may comprise a roll stick configured to affect rotation of the UAV about a roll axis and/or a yaw stick configured to affect a rotation of the UAV about a yaw axis. In some instances, the one or more control sticks may comprise a pitch stick configured to affect rotation of the UAV about a pitch axis. Alternatively, the pitch stick may be configured to affect change in a velocity of the UAV. In some instances, the one or more control sticks may comprise a throttle stick. The throttle stick may be configured to affect a change in a height (e.g., altitude) of the UAV. For example, pushing the throttle stick up or down may cause the UAV to ascend or descend correspondingly. In some instances, the throttle stick operating in combination with a control stick for controlling the flight direction can affect how quickly UAV flies to a given location, for example, affecting the linear velocity of the UAV. The more the throttle stick is pushed away from its neutral position, the faster the UAV will fly to the given location. Likewise, the less the throttle stick is pushed away from the neutral position, the slower the throttle stick will fly to the given location. By pushing the pitch or yaw stick, the UAV may rotate accordingly around its pitch or yaw axis, thereby resulting in the changes of the flight direction. For example, by pushing the pitch stick, the UAV may rotate around its pitch axis, thereby changing elevation of the UAV.

By manual operations, the user may be able to actuate at least one of one or more control sticks to enter user instructions. The user instructions can then be transmitted by the remote controller to the UAV via any suitable communication technique as discussed before. The user instructions herein and elsewhere in the specification can be used to plan or amend a flight trajectory, configure or change multiple flight parameters, switch operating modes, configure or amend an operational area, as non-limiting examples. For instance, the one or more user instructions may be transmitted from a remote controller to a flight controller of the UAV which may generate, with aid of one or more processors, a set of signals that modify the autonomous flight of the UAV, e.g., by affecting a rotation of the UAV about one or more axes, by affecting a change in velocity of the UAV, or by affecting a change in a height of the UAV. As an example, the flight controller of the UAV may generate a set of signals that further instruct one or more propulsion units to operate in order to modify the autonomous flight of the UAV, e.g., by affecting a rotation of the UAV about one or more axes. In some instances, actuation of the roll stick may affect rotation of the UAV about a roll axis while actuation of the yaw stick may affect rotation of the UAV about the yaw axis, e.g., while maintaining autonomous flight of the UAV. In some instances, actuation of the throttle stick may affect a height of the UAV while actuation of the pitch stick may affect a velocity of the UAV.

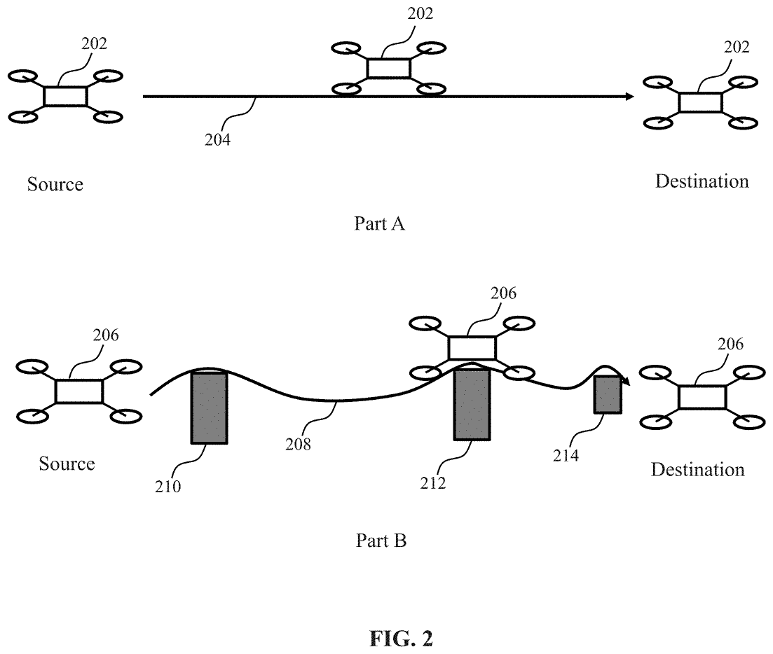

FIG. 2 shows a schematic view of UAVs 202 and 206 flying along different planned trajectories 204 and 208, in accordance with embodiments of the disclosure. It is to be understood that the UAV as discussed herein with reference to FIG. 2 may be identical or similar to (or share one or more characteristics with) the UAV as discussed above with reference to FIG. 1. Therefore, any description of the UAV in reference to FIG. 1 may equally apply to the UAV as discussed below and elsewhere in the specification.

As illustrated at Part A of FIG. 2, a UAV 202 may fly from a source (e.g., a takeoff point) to a destination (e.g., a landing point) along a planned trajectory or flight trajectory 204. Although it is illustrated that the planned trajectory is from the source to the destination, the planed trajectory may also be from a first waypoint to a second waypoint, from a first location to a second location, or from a location to a target, etc. Further, as illustrated at Part B of FIG. 2, a UAV 206 may fly from a source to a destination along a planned trajectory 208. As apparent from the illustration, the planned trajectory 204 is shown as linear while the planned trajectory 208 is shown as curved due to presence of one or more obstacles 210, 212, and 214. The flight trajectory herein may be a flight path that a UAV takes during flight. The flight trajectory may include one or more points or waypoints of interest such that the UAV may fly through each of these desired points. For example, waypoints may include two dimensional (2D) or three dimensional (3D) coordinates for the UAV to fly through. Alternatively, the one or more waypoints may indicate or represent one or more obstacles that the UAV should avoid during the flight. In some embodiments of the disclosure, the flight trajectory can be generated or planned without regard to one or more possible obstacles along the flight trajectory. In some instances, a plurality of flight trajectories associated with a specific route or path can be provided for user selection.

A flight trajectory may have one or more characteristics that can be configured by a user. The one or more characteristics herein may include but are not limited to a size, a shape, a distance, an effective time, display options and the like. For example, the size and the shape of the flight trajectory can be set or configured by the user such that it can be easily noticed by the user on a display device, which may be integrated on the remote controller or a separate device as exemplarily shown in FIG. 1. In some instances, the shape of the flight trajectory can be two dimensional, for example, a straight line or a curved line with a preset width. Additionally, the shape of the flight trajectory can be three dimensional, for example, a cylindrical shape or rectangular shape. In some implementations, the flight trajectory may be a line itself with three dimensions, wherein, for example, the altitude of the line can be configured and changed. The effective time of the flight trajectory is a predetermined period of time that the use sets to be associated with an autonomous flight. For example, the UAV may perform autonomous flight during this predetermined period of time along the planed flight trajectory after which the user may be able to manually control the UAV to fly. In some embodiments, flight trajectories may comprise a flight trajectory with the shortest flight path, a flight trajectory with the least obstacles, a flight trajectory with the highest safety level (e.g., not crossing any restricted area that the UAV cannot fly into). In some instances, the flight trajectory may be entirely planned, i.e., a whole path is predetermined. Alternatively, the flight trajectory may be partially determined. For example, some points along a continuous path can be predetermined and a flight trajectory of the UAV between those points may be variable. The points and/or the entirety of the path can be selected by a user or one or more processors of the external system, e.g., a display device.

The flight trajectory may be established between a source (e.g., a takeoff point) and a destination (e.g., a landing point) with or without taking into account any obstacles appearing along the flight trajectory. The flight trajectory may be planned prior to or during the flight of the UAV. Alternatively, a flight trajectory may be generated or updated as a background procedure after the flight of the UAV such that the user may be able to select a preferred or recommended flight trajectory before the next flight of the UAV. In some implementations, the user may be able to amend or change the planned flight trajectory during the flight of the UAV. For example, during the flight of the UAV, the user may be able to amend one or more characteristics of the flight trajectory that the UAV is taking to obtain a changed flight trajectory. Upon confirming the changed flight trajectory, a control instruction corresponding thereto may be wirelessly transmitted to the UAV and executed by one or more processors on-board the UAV, thereby effecting the flight of the UAV along the changed flight trajectory. In some cases, the planned trajectory may be changed by the user input such that the UAV is permitted to fly autonomously along the changed planned trajectory.

In some embodiments, a flight trajectory may be generated upon configuration of one or more characteristics as discussed above and may be changed by amending the one or more characteristics. In some instances, a user may generate a flight path for the UAV by drawing a contour on a touch sensitive screen with a user interactive device (e.g., a stylus) or with a finger. The generated flight trajectory may be displayed in a graphic user interface (GUI) on a remote controller or a separate device as illustrated in FIG. 1. Alternatively or additionally, a plurality of waypoints that are indicative of targets towards which the UAV is autonomously flying may be displayed in the GUI. For example, the user may touch the GUI with finger(s) or stylus, or manually input coordinates to enter the waypoints. Then, the remote controller or the separate device can generate a flight trajectory between points. Alternatively, the user can draw the lines between the points via the GUI. When the flight trajectory is generated by the remote controller or the separate device, the user may be able to specify different types of trajectory—e.g., with a shortest distance, most fuel efficient, good communications, etc.

In some instances, a flight trajectory may be generated autonomously or semi-autonomously. In some instances, a flight trajectory may be generated relative to a target by taking into account a position, orientation, attitude, size, shape, and/or geometry of the target. In some instances, the flight path may be generated autonomously or semi-autonomously by taking into account parameters such as parameters of a UAV (e.g., size, weight, velocity, etc), jurisdictional parameters (e.g., laws and regulations), or environmental parameters (e.g., wind conditions, visibility, obstacles, etc). In some instances, the user may modify any portion of a flight trajectory by adjusting (e.g., moving) different spatial points of the motion path on a screen, e.g., click and drag a waypoint or touch and pull a part of the path, etc. Alternatively, the user may select a region on a screen from a pre-existing set of regions, or may draw a boundary for a region, a diameter of a region, or specify a portion of the screen in any other way, thereby generating a flight trajectory.

An autonomous flight may be any flight of the UAV that does not require continued input (e.g., real time input) from a user. In some instances, the autonomous flight may have a predetermined task or goal. Examples of the predetermined task or goal may include, but are not limited to tracking or following a target object, flying to a target area or a desired location, returning to a location of the user or a user terminal. In some instances, an autonomous flight may have a predetermined target that the UAV is moving towards. The target may be a target object or a target destination. For example, an autonomous flight may be an autonomous flight towards a predetermined location indicated by the user. In some instances, an autonomous flight may be a flight to a predetermined location, an autonomous return of the UAV, an autonomous navigation along a planned trajectory or along one or more waypoints, autonomous flight to a point of interest.

During an autonomous flight, a UAV may measure and collect a variety of data, make decisions, generate one or more flight control instructions, and execute corresponding instructions as necessary for the autonomous flight with aid of one or more of one or more propulsion units, one or more sensors, one or more processors, various control systems and transmission systems (e.g., a flight control system, a power system, a cooling system, a data transmission system) and other components or systems on-board the UAV. Some examples of types of sensors may include location sensors (e.g., global positioning system (GPS) sensors, mobile device transmitters enabling location triangulation), motion sensors, obstacle sensors, vision sensors (e.g., imaging devices capable of detecting visible, infrared, or ultraviolet light, such as cameras), proximity or range sensors (e.g., ultrasonic sensors, lidar, time-of-flight or depth cameras), inertial sensors (e.g., accelerometers, gyroscopes, and/or gravity detection sensors, which may form inertial measurement units (IMUs)), altitude sensors, attitude sensors (e.g., compasses), pressure sensors (e.g., barometers), temperature sensors, humidity sensors, vibration sensors, audio sensors (e.g., microphones), and/or field sensors (e.g., magnetometers, electromagnetic sensors, radio sensors).

In some situations, one or more flight control instructions may be pre-programmed and stored in one or more storage units on-board the UAV. Upon execution of the one or more flight control instructions by the one or more processors, the UAV can fly in an autonomous mode towards a given destination or target. In some embodiments, the one or more processors may be configured to permit the UAV to fly autonomously along a planned trajectory when no user input is received by one or more receivers of the UAV. Further, the one or more processors may be configured to permit the UAV to autonomously deviate from the planned trajectory so as to avoid one or more obstacles present along the planned trajectory, such as scenarios shown at Part B of FIG. 2 where the UAV 206 may autonomously deviate from the planned trajectory 208 due to the presence of the obstacles 210, 212 and 214. The obstacles herein may be an obstacle that is pre-known according to e.g., a pre-stored electronic map. In contrast, an obstacle may be a moving obstacle or may not be pre-known. In this case, the unknown obstacle may be sensed by the UAV and an evasive action may be performed by the UAV. Therefore, the UAV may perform automatic obstacle avoidance in the autonomous mode. Additionally, the one or more processors may be configured to permit the UAV to autonomously return back to the planned trajectory, for example, from semi-autonomous flight or manually-controlled flight when no user input is received within a period of time. The period of time herein may be set by a user via a remote controller or a display device connected to the remote controller.

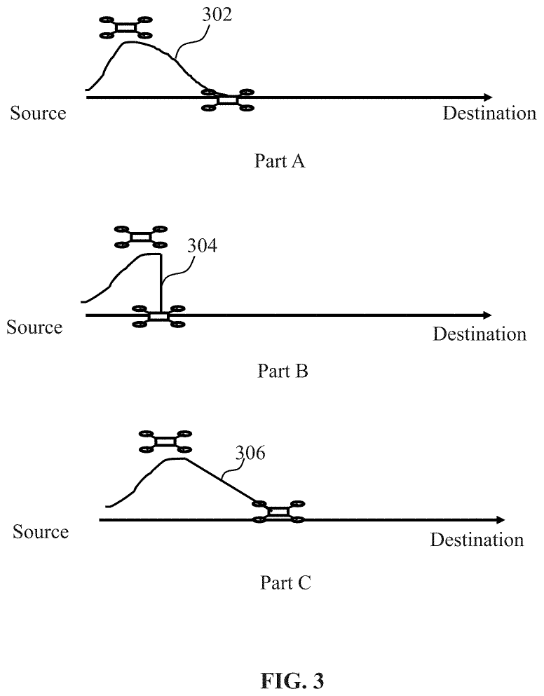

In some embodiments, an autonomous flight of a UAV back to a planned trajectory may comprise a progressively smooth flight back to the planned trajectory along a curved path intersecting with the planned trajectory, such as a curved path 302 exemplarily shown at Part A of FIG. 3. In some implementations, a user can preset the length, curvature or radian of the curved path such that the UAV, after deviating from the planned trajectory, may be able to fly back to the planned trajectory along this preset curved path. Additionally or alternatively, an autonomous flight of a UAV back to a planned trajectory is along a shortest path intersecting with a planned trajectory, such as a shortest path 304 exemplarily shown at Part B of FIG. 3. In this case, the UAV may project its current location to a point in the planned trajectory in a vertical direction or lateral direction (e.g., non-forward direction) with aid of location sensors and then fly towards the projected point in the vertical direction, thereby returning back to the planned trajectory. In some instances, this may depend on the maneuver that the UAV made to avoid obstacle. For example, if the UAV is sent up to avoid the obstacle, then it may move in the vertical direction to go back to the flight trajectory. However, if the UAV flies sideway to avoid the obstacle, then it may need to move sideways to go back on the flight trajectory. In some scenarios, the user may specify a path or route that the UAV will take to return back to the planned trajectory after deviating therefrom, such as a specified path 306 exemplarily shown at Part C of FIG. 3. Unlike the curved path as shown at Part A of FIG. 3, the specified path can be any path with a slope, angle or radian as desired by the user. Alternatively or in addition, the return path could follow various parameters, for example, shortest, fastest, least amount of energy consumption, any of these while maintaining the forward speed. In some instances, the return path may further depend on environmental conditions, for example, the weather, types of the obstacles, or environmental density. For example, the return path may avoid the path with extreme weather or the path with one or more obstacles.

In some embodiments, the UAV may periodically or non-periodically transmit wireless signals to a remote controller in an autonomous mode. The wireless signals herein may include or represent a variety of data, for example, measured or sensed data, such as those associated with the ambient environment and measured by various kinds of sensors, operating data associated with operations of the various units and systems, such as the remaining power, speeds of rotation of the propellers, operating states, image data collected by an image capture device coupled to the UAV via a carrier (e.g., a gimbal). In some instances, the wireless signals herein may include a request signal requesting user input from a user, for example, when the UAV is flying or about to fly toward one or more obstacles, or when the UAV is about to fly into a restricted area, or when operational data collected by one or more sensors on-board the UAV indicates that the user input is needed, or when the UAV is about to fly out of the operational area, or when the UAV is about to fly into the operational area. The request signal herein may be graphically displayed on a screen that is being observed by the user. Additionally or alternatively, the request signal may be an audible signal that can be heard by the user.

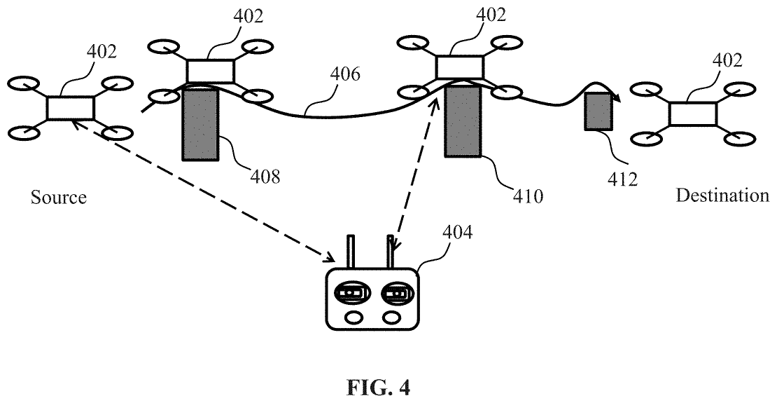

FIG. 4 shows a schematic view of a UAV 402 operating in a manually-controlled mode via a remote controller 404, in accordance with embodiments of the disclosure. The UAV and remote controller illustrated in FIG. 4 may be identical or similar to (or share one or more characteristics with) the ones as illustrated in FIG. 1. Thus, any descriptions of the UAV and remote controller as discussed with reference to FIG. 1 may also apply to the UAV and remote controller as illustrated in FIG. 4. A separate device (e.g., a display device with a touch sensitive screen) that connects to the remote controller to receive user inputs and control the UAV via the remote controller, such as the one shown in FIG. 1, may optionally be provided and is omitted in the figures only for a simple illustrative purpose. A person skilled in the art can envisage that any kinds of suitable user terminals can be used for receiving user input and facilitating the manual control of the UAV.

As exemplarily illustrated in FIG. 4, while flying along a planned flight trajectory 406, the UAV may deviate from the planned flight trajectory due to presence of one or more obstacles 408, 410, and 412 (such as trees, buildings, or the like) along the planned flight trajectory. In some cases, the avoidance of the UAV from the one or more obstacles may be performed solely by the UAV without any assistance or user input from the user, i.e., autonomous obstacle avoidance. Alternatively or in addition, the avoidance of the UAV from the one or more obstacles may be performed manually, i.e., based on the user input from a remote user via a remote controller, just as the one 404 shown in FIG. 4. The user input herein or elsewhere in the specification may be provided via a user interface disposed on a remote controller, e.g., buttons or control sticks as previously described, and may be used to carry out manual direct control over the UAV. It is to be understood that user intervention may be helpful in facilitating the flight of the UAV in a safer or more efficient way.

In some scenarios, an autonomous flight may be modified in response to a user input. The user input may provide one or more instructions to modify or affect the autonomous flight of the UAV. The one or more instructions may be transmitted wirelessly to a flight controller of the UAV, which may, in response to the received one or more instructions, generate a second set of signals that modify the autonomous flight of the UAV. For example, the flight controller may generate a second set of signals that further instruct one or more propulsion units to operate in order to modify the autonomous flight of the UAV. In some instances, the modification of the autonomous flight may disrupt, or stop the autonomous flight of the UAV, e.g., until further user input is received. For example, a UAV whose autonomous flight has been disrupted may manually be controlled by the user via the remote controller. In some instances, a UAV whose autonomous flight has been disrupted may hover at a location where the user input has been provided until further instructions are given. Alternatively, the UAV whose autonomous flight has been disrupted may return to the user, or user terminal, or proceed to land. Additionally, a UAV whose autonomous flight has been disrupted may proceed with flying in a manually-controller mode irrespective of the flight components or parameters generated by the UAV in the autonomous flight.

The user input may be required or triggered under different situations or in different scenarios. For example, the user input can be made during the flight of the UAV as necessary. In other word, whenever the user would like to input some instructions to change the autonomous flight of the UAV, he or she can immediately operate the remote controller to make corresponding user input, for example, by pressing the buttons or moving the control sticks on the remote controller. In some cases, the user input may be provided for one or more specific purposes. For example, the user input may be provided for changing one or more flight parameters of the UAV, changing the currently-followed flight trajectory, or avoiding one or more obstacles along the flight trajectory. For example, a UAV may autonomously fly along a flight trajectory and an obstacle along the flight trajectory may be detected, e.g., by sensors on-board the UAV or visually by a user controlling the UAV. When the user tries to control the UAV to avoid the obstacle, he or she may provide a command that causes the UAV to avoid the obstacle. As an example, the user can alter the flight trajectory to cause the UAV to veer away from the obstacle—e.g., diverting the UAV away from obstacle. The flight parameters herein may include one or more parameters associated with the autonomous flight of the UAV. In some instances, the flight parameters may include but are not limited to a flight direction, a flight orientation, a flight height, a flight speed, acceleration or the like.

In some instances, the one or more flight parameters input via the user input may substitute or replace one or more flight parameters currently applied by the UAV in the autonomous flight. For example, when the user changes the flight speed of the UAV via the remote controller, a new flight speed can be generated and applied to replace the currently-applied flight speed, i.e., the change made the user is an absolute change instead of a relative change relative to the currently-applied flight speed. Alternatively, the one or more flight parameters input via the user input may be added to the one or more flight parameters currently applied by the UAV in the autonomous flight. For example, the user may be able to add a directional component to an autonomous flight path of the UAV or may modify the autonomous flight path by adding a velocity or acceleration component to the UAV flying in the autonomous mode. In other words, the user input made via the remote controller can be combined with autonomous flight instructions generated on-board the UAV. After such a combination, the UAV may still be able to fly autonomously along the planned flight trajectory.

In some scenarios, user input may be required for manually avoiding one or more obstacles along the planned trajectory. In such a case, a user may observe that there is an obstacle in a flight trajectory of the autonomously operating UAV. By manipulating (e.g., moving or pushing) the control sticks on the remote controller, the user may be able to easily avoid the one or more obstacles, resulting in a deviation from a planned flight trajectory. After avoiding the obstacle, the user may release the control sticks and the UAV may continue to autonomously operate by returning autonomously back to the planned flight trajectory first, in one of manners as exemplarily illustrated in FIG. 3. In some cases, after avoiding the obstacle, the UAV may not automatically enter into the autonomous flight and the user may manually control the UAV until it lands on a target or preset destination, or until a given task is done.

Alternatively, after avoiding the obstacle, the user may amend the planned flight trajectory or configure a wholly-new flight trajectory such that the UAV may continue to autonomously fly along the changed flight trajectory or the wholly-new flight trajectory.

In some situations, the UAV may send a request signal to a remote user, asking for user input from the remote user. This sometimes may be due to some emergency conditions. As an example, the UAV may send such a request signal when it is self-determined that it is about to collide with one or more obstacles. As another example, the UAV may send such a request signal when it is self-determined that it is about to fly into a restricted area into which a UAV is not allowed to fly, e.g., a military area, a restricted fly zone or an area experiencing extreme weather. As a further example, the UAV may send such a request signal when it is self-determined that it cannot perform the autonomous flight anymore due to failure of one or more sensors, such as position sensors. In some implementations, the UAV may send such a request signal when a period of time as specified by the user for the autonomous flight expires. It should be understood that the UAV may send such a request signal under any other suitable situations as envisaged by those skilled in the art based on the teaching herein and elsewhere in the specification. For example, such a request signal can be sent out when a battery level is lower than a specific threshold or if any of power outage, error of any components, overheating, etc., arises. In some instances, when some of these issues arise, the UAV may not be capable of continuing the autonomous flight but may be capable of operating in one of the semi-autonomous mode or manually-controlled mode.

In some instances, one or more processors of a UAV may be configured to permit the UAV to switch between an autonomous flight and a user-intervened flight, which may include one of the semi-autonomous flight and manually-controlled flight. Thereby, a seamless transition between an autonomous flight of the UAV and user-intervened flight of the UAV may be enabled. For example, upon receipt of user input from a remote controller by one or more receivers of the UAV, the one or more processors may permit the UAV to transfer from the autonomous flight to the manually-controlled flight based on the user input. As mentioned before, the user input herein may be implemented via a control stick on the remote controller. As another example, the user input may be implemented via a graphic user interface shown on a terminal device (e.g., a display device) that is connected to the remote controller. In this manner, the user may be able to enter user instructions by touching or clicking one or more graphic items on the graphic user interface.

As another example, the one or more processors may permit the UAV to automatically change into an autonomous flight from a manually-controlled flight. In some cases, it may occur after the changed flight parameters are effective or may occur after the obstacles are avoided. In particular, the UAV may be able to continue with the autonomous flight based on the changed flight parameters along the planned flight trajectory or may be able to return back to the planned flight trajectory after manually avoiding one or more obstacles appearing along the planned trajectory. For example, after manually avoiding the one or more obstacles, one or more processors of a UAV are configured to permit the UAV to autonomously return back to the planned trajectory along a curved path intersecting with the planned trajectory. Alternatively, the one or more processors are configured to permit the UAV to autonomously fly back to the planned trajectory along a shortest path intersecting with the planned trajectory or along a path specified by the user.

In some cases, automatically changing into the autonomous flight from the manually-controlled flight may occur when no user input is received within a time period as preset by the user. For example, the user may set a period of time, such as less than one hundredth, one tenth, one, two, three, five, ten, fifteen, twenty, twenty-five, thirty, thirty-five, forty, or fifty seconds, or such as one, two, or three minutes, after which, if no user instruction is received, the UAV may automatically change into the autonomous flight mode and proceed with autonomously flying along the planned trajectory. In some implementations, this may occur as soon as inputs are released (e.g., the neutral position of control stick, user no longer touching touchscreen, user no longer depressing button, etc), or this may occur within any of the timeframes specified by the user. In some instances, an affirmative indication is unnecessary for switching the UAV back to the autonomous mode. Alternatively or in addition, user may provide affirmative input for the UAV to return to autonomous mode.

Seamless transition between autonomous flight and modification of the autonomous flight due to user input may be possible such that the burden of manually piloting the UAV on the user can be significantly reduced, while still enabling a degree of control by the user when desired or advantageous.

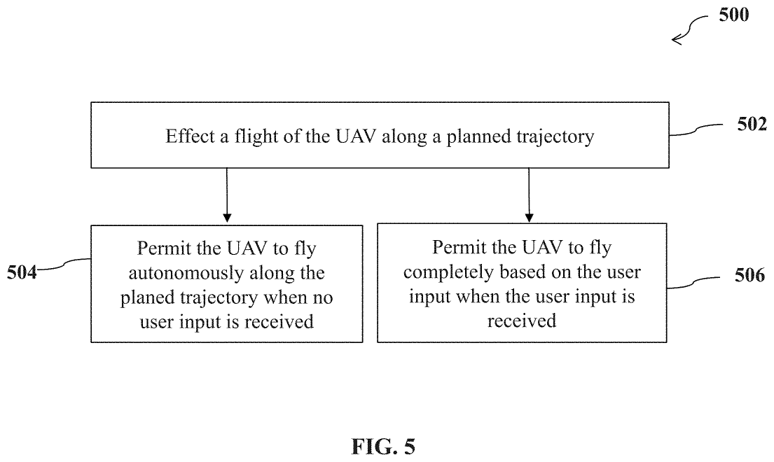

FIG. 5 shows a flow chart of a method 500 for controlling flight of a UAV, in accordance with embodiments of the disclosure. It is to be understood that the method discussed herein may be implemented between a UAV and a remote controller. Therefore, any description of the UAV and remote controller as discussed before may also be applied to the UAV and remote controller as discussed hereinafter with reference to FIG. 5.

As illustrated in FIG. 5, at 502, the method may effect a flight of the UAV, with aid of one or more propulsion units, along a planned trajectory. At 504, the method may permit, with aid of one or more processors, the UAV to fly autonomously along the planned trajectory when no user input is received. Additionally, at 506, the method may permit, with aid of the one or more processors, the UAV to fly completely based on the user input when the user input is received.

The planned trajectory as mentioned with reference to FIG. 5 may be identical or similar to (or share one or more characteristics with) those as discussed before with reference to any of FIGS. 1-4. For example, the planned trajectory may be planned prior to flight of the UAV without regard to presence of one or more obstacles along the planned trajectory. In this way, the user may have greater freedom of planning a desirable trajectory without needing to consider any restrictions imposed by the obstacles. In some situations, the user may be able to amend or change the planned trajectory such that the UAV is permitted to fly autonomously along the changed planned trajectory.

The one or more processors may further permit the UAV to continue with the autonomous flight along the planned trajectory after the user input is executed. In other words, the UAV is changed from the manually-controlled mode to the autonomous mode after the user input has been performed. In some instances, the one or more processors may permit the UAV to deviate from the planned trajectory based on the user input. For instance, the one or more processors may permit the UAV to deviate from the planned trajectory to avoid one or more obstacles present along the planned trajectory based on the user input. Further, after deviating from the planned trajectory, the one or more processors may permit the UAV to autonomously return back to the planned trajectory, for example, via a progressively smooth flight along a curved path, via a shortest path intersecting the planned trajectory, or via a path specified by the user.

In some embodiments, the method may further comprise transmitting a request signal from the UAV to the remote controller for requiring the user input, for example, upon detecting one or more obstacles along the planned trajectory, or based on operational information collected by one or more sensor on-board the UAV. After manually controlling the UAV, the UAV may be permitted to return back to the autonomous flight when no user input is received within a period of time. The period of time can be set by the user via the remote controller. In some implementations, this may occur as soon as inputs are released (e.g., the neutral position of control stick, user no longer touching touchscreen, user no longer depressing button, etc), or this may occur within any of the timeframes specified by the user. In some instances, an affirmative indication is unnecessary for switching the UAV back to the autonomous mode. Alternatively or in addition, user may provide affirmative input for the UAV to return to autonomous mode.

The remote controller for controlling operations of the UAV may comprise a user interface configured to receive user input from a user. The remote controller may further comprise a communication unit configured to transmit, while the UAV is in an autonomous flight along a planned trajectory, an instruction for the UAV to fly completely based on the user input, wherein the UAV is configured to fly autonomously along the planned trajectory when no user input is received.

In some embodiments, the communication unit of the remote controller may transmit an instruction for the UAV to deviate from the planned trajectory based on the user input, for example, due to the presence of one or more obstacles along the planned trajectory. The communication unit may also transmit an instruction for the UAV to return back to the planned trajectory based on the user input. In some instances, the instructions transmitted by the communication unit of the remote controller based on the user input are in response to a request signal received from the UAV. To receive the user input, the user interface may be configured to comprise one or more control sticks for receiving the user input to, for example, change one or more flight parameters of the UAV. The one or more flight parameters herein may include one or more of a flight direction, a flight orientation, a flight height, a flight speed, acceleration, or a combination thereof.

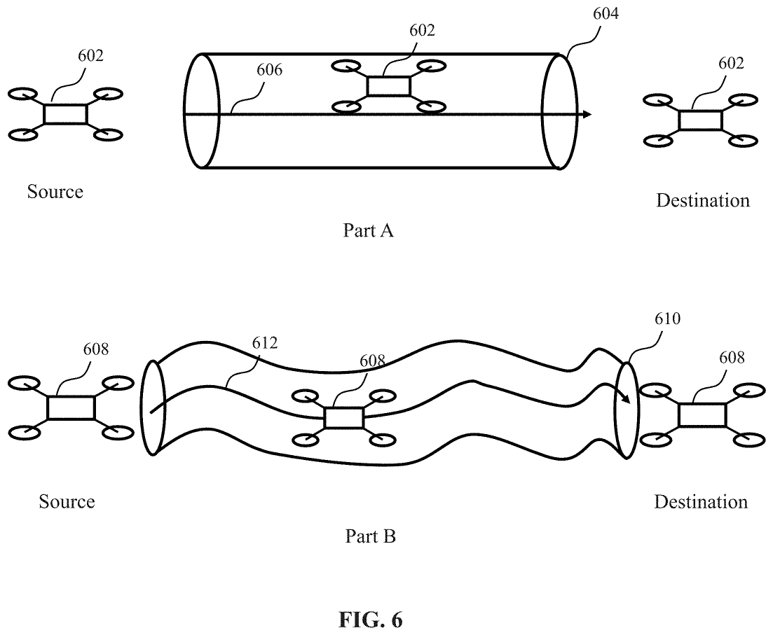

FIG. 6 show schematic views of UAVs 602 and 608 flying in different operational areas, in accordance with embodiments of the disclosure. The UAVs as illustrated in FIG. 6 may be identical or similar to (or share one or more characteristics with) the ones as discussed before with reference to any of FIGS. 1-5. Therefore, any description of the UAV as made before may also be applicable to the UAV as illustrated in FIG. 6. The operational area herein may also be referred to as an operational space, an operational zone, a trajectory control region, etc., and thus they can be interchangeably used in the context of the specification.

As illustrated at Part A of FIG. 6, the UAV 602 may take off at a source, fly along a planned trajectory 606 within an operational area 604 as proposed by the disclosure, and land at a destination. Similarly, as illustrated at Part B of FIG. 6, the UAV 608 may also take off at a source, fly along a planned trajectory 612 within an operational area 610 as proposed by the disclosure, and land at a destination. It is apparent that the operational areas 604 and 610 as illustrated have different shapes.

In some embodiments, an operational area may be an area that can be configured and set by a user via a user terminal having a graphic user interface. Thereby, the user may be able to control the UAV based on whether it is within the operational area or not. For example, when the UAV is within the operational area, it can be controlled to fly in accordance with a first set of control rules. Further, when the UAV is not within the operational area, i.e., in a non-operational area, it can be controlled to fly in accordance with a second set of control rules. In some instances, the first set of control rules may be as same as the second set of control rules. In some instances, the first set of control rules may be different from the second set of control rules. The control rule herein may also be referred to as the control logic, strategy, parameters, etc.

The operational area may be capable of one or more parameters, which may be used to form a three dimensional space. The one or more parameters are related to one or more geometric characteristics and may include but are not limited to a shape, a size, a cross section, a dimension, continuity, and divisibility. For example, the cross section of the operational area may be circular, triangular, rectangular, and any other suitable shape. In other word, the operational area herein may have a three-dimensional structure. For example, a cross-section of the operational area may have any shape, including but not limited to a circle, a triangle, rectangle, a square, a hexagon, etc. Therefore, a dimension parameter of the operational area may be lengths of sides when the cross section of the operational area is triangular. Further, a dimension parameter of the operational area may be a radius or a diameter and a length when the cross section of the operational area is circular. Likewise, a dimension parameter of the operational area may be a length, a width and a height when the cross section of the operational area is rectangular. In some embodiments, when the operational area is configured to have a regular shape, a flight trajectory may be a central axis of the operational area. Therefore, an operational area may be defined with respect to a flight trajectory. For example, when a flight trajectory is determined, it may then be used as a central axis of an operational area and therefore the operational area can be set up by centering around this central axis. Alternatively, a flight trajectory can be at a center of a cross-section of an operational area, or can be off-center of the cross-section of the operational area. In some embodiments, the size, area or shape of the operational area may change along the length of the operational area. Additionally, the operational area may extend along the entirety of length of the flight trajectory or can cover only parts or sections of the flight trajectory.

In some instances, an operational zone can be defined with fully-enclosed boundaries, or can be open, semi-open or semi-enclosed (i.e., partially enclosed). For example, the operational area may be constituted by two parallel planes in a vertical direction between which the UAV may fly along a flight trajectory.

In some embodiments, the continuity or divisibility may be configured or selected by the user. For example, the operational area may be continuous or discontinuous between a source and a destination. When an operational area is discontinuous, it may include a plurality of subareas and accordingly a flight trajectory arranged within the operational area may also include a plurality of trajectory segments, each of the plurality of trajectory segments being associated with a corresponding one of the plurality of subareas. In some instances, the plurality of subareas may be configured to space apart from one another with a same interval or different intervals. The plurality of subareas may be configured to have a same size or different sizes, a same shape or different shapes, or a same control rule or different control rules.

The one or more parameters of the operational area as discussed above may be determined in response to user input, for example, when planning a flight trajectory of the UAV. The flight trajectory may be planned without regard to presence of one or more obstacles along the flight trajectory, thereby the user being capable of more freely determining a desirable flight trajectory. The flight trajectory may be planned in a same manner as those discussed before and thus a further description thereof is omitted for purpose of clarity. In some instances, one or more parameters of an operational area may be configured by a software development kit on-board a UAV or off-board the UAV. In some instances, one or more parameters are configured by a user interface with a plurality of options corresponding to the one or more parameters. As an example, the user interface may be arranged on a UAV. In another example, the user interface may be arranged on a remote controller capable of remotely controlling the UAV. In a further example, the user interface may be arranged on a display device that connects to the remote controller and user input for configuring the operational area can be received by the display device and then transmitted to the remote controller, which may control the UAV to fly in accordance with the user input.

In some embodiments, an operational area may be configured or set after the UAV takes off, i.e., during the flight of the UAV, in response to a user input. In this case, the use may be able to set an operational area for the flight of the UAV at any time while the UAV is flying in the air. For example, after the UAV takes off and has been flying for nearly ten minutes along a planned trajectory, the user may want the UAV to fly within an operational area. Therefore, the user may configure the operational area in a way as discussed above and once finished, the user may instruct the UAV via the remote controller to fly within the operational area immediately or after a given period of time. Thereafter, the UAV may be controlled differently from before where no operational area is involved. In another case, an operational area may be automatically generated in response to detecting one or more obstacles along the flight trajectory while the UAV is flying. For example, when the UAV detects an obstacle in the flight trajectory with aid of one or more sensors, e.g., obstacle sensors, an operational area encompassing the obstacle may be generated and graphically shown on the display device for user's observation and control. After the operational area is generated, the UAV may be controlled to fly in accordance with the control rules in order to avoid the obstacle, as will be discussed in detail later.

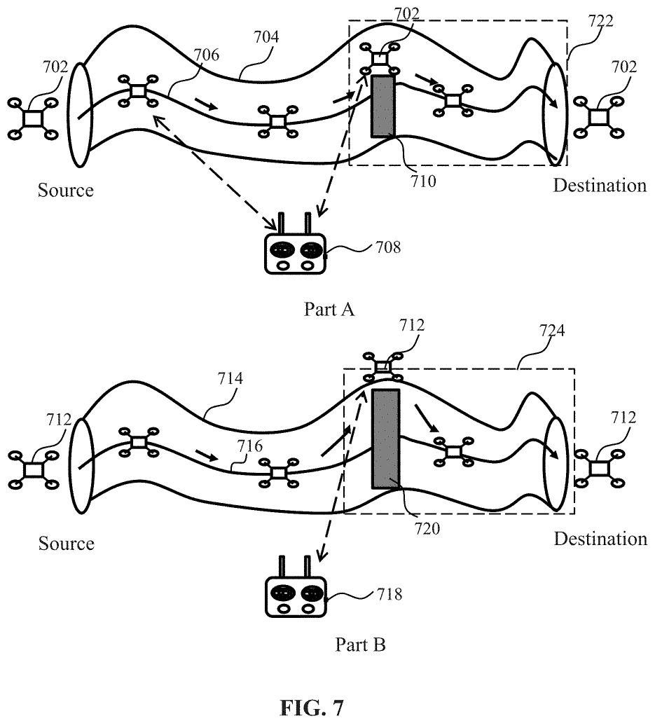

FIG. 7 show schematic views of UAVs 702 and 712 flying in operational areas 704 and 714 and a non-operational area, in accordance with embodiments of the disclosure. It is to be understood that the UAV herein may be identical or similar to (or share one or more characteristics with) those as discussed before with respect to any of FIGS. 1-6. Therefore, any description of UAV as made before may apply to the UAV as discussed below. Further, the operational areas herein may be identical or similar to (or share one or more characteristics with) the one as illustrated in FIG. 6. Therefore, any description of the operational areas as made above with reference to FIG. 6 may also apply to the operational areas as illustrated in FIG. 7.

As illustrated at Part A of FIG. 7, the UAV 702 is illustrated as flying along a flight trajectory 706 within the operational area 704 from a source to a destination. One or more propulsion units may be configured to generate lift to effect the flight of the UAV. During the flight of the UAV, one or more processors on-board the UAV may be configured to obtain an indication of whether the UAV is flying within the operational area. For example, with aid of one or more sensors, such as position sensors or proximity sensors, one or more processors of the UAV may obtain current location information (e.g., a 3D coordinate) of the UAV, and then upon comparing its current location with the coverage of the operational area, the UAV may determine whether it is within the operational area or outside the operational area. In some embodiments, the indication may be obtained from a user via a remote controller by visual observation of the user. Alternatively or in addition, the remote controller may be configured to regularly or irregularly transmit an indication signal indicative of whether the UAV is within the operational area or outside the operational area to the UAV. To this end, in some instances, the UAV may keep transmitting the signal regarding the current location to the remote controller and thereby the remote controller may determine whether the UAV is within the operational area or outside the operational area by determining whether the current location of the UAV falls into the coverage of the operational area.

If the indication indicates that the UAV is flying within the operational area, such as exemplarily shown at Part A of FIG. 7, then the one or more processors may be configured to generate one or more flight control signals to cause the UAV to fly in accordance with a first set of control rules. In contrast, if the indication indicates that the UAV is flying outside the operational area, such as exemplarily shown at Part B of FIG. 7, then the one or more processors may be configured to generate one or more flight control signals to cause the UAV to fly in accordance with a second set of control rules. In some embodiments, the operational area herein may be defined with respect to a flight trajectory, such as the flight trajectories 706 and 716 illustrated in FIG. 7.

The operational area may remain unchanged during a flight of the UAV along a flight trajectory. For example, once the operational area has been configured and put into use, it will not be changed throughout the flight trajectory, i.e., from a source to a destination. In contrast, the operational area may be changed during the flight of the UAV. For example, the operational area may be changed in response to the user input when the user would like to change the operational area, e.g., for better control of the UAV. In some instances, the operational area may be changed due to the change of the flight trajectory. In particular, during the flight of the UAV, the user may change the flight trajectory due to the presence of an obstacle, and therefore, the operational area may also be correspondingly changed to match the changed flight trajectory. In some instances, after avoiding one or more obstacles, the UAV may fly outside of the configured operational area, i.e., in a non-operational area. In this case, the user may amend the operational area, for example, changing the size or shape of the operational area, to stretch or enlarge the operational area such that the UAV may fly within the enlarged operational area, thereby retaining the same control rules unchanged for the UAV.

In some embodiments, when the UAV is within an operational area, its flight may follow the flight trajectory in accordance with the first set of control rules. As an example, under the control of the first set of control rules, the UAV may operate in an autonomous mode without any assistance (e.g. user input) from a remote user. In this case, when flying within the operational area, one or more processors of the UAV may be configured to permit the UAV to fly autonomously along the flight trajectory. In some embodiments, the autonomous flight of the UAV following the flight trajectory may be based at least in part on one of a plurality of conditions. The plurality of conditions herein may include but are not limited to one or more of absence of an obstacle along the flight trajectory, absence of an undesirable environmental factor within the operational area, and absence of a restricted area within the operational area. For example, if there is no obstacle along the flight trajectory, the UAV may remain operating in the autonomous mode in accordance with the first set of control rules, i.e., flying autonomously without needing to deviate from the flight trajectory. Of course, the plurality of conditions as discussed herein are only for illustrative purposes and the autonomous flight may be performed even when one or more conditions are not met. For example, the autonomous flight may be performed even if one or more obstacles are present along the flight trajectory. In this case, the autonomous obstacle avoidance may be performed by the UAV to avoid the one or more obstacles.

In some instances, when flying within the operational area, the UAV may receive user input from the user via a remote controller 708 for e.g., amending one or more flight components of the UAV, or for controlling a carrier supported by the UAV. For example, the user may want to speed up the UAV by increasing acceleration of the UAV, or want to adjust an angle of view of an image capture device attached to the carrier. These kinds of changes or adjustments may not affect the autonomous flight of the UAV and therefore the UAV may still be able to fly in accordance with the first set of control rules. For instance, the UAV may continue to fly autonomously along the flight trajectory. In some instances, according to the first set of control rules, the UAV may be manually controlled by the user when one or more user inputs are received by the UAV while flying in the operational area. In this case, the UAV may be in a manually-controlled flight or in a semi-autonomous flight. For example, based on the user's pre-configuration, the UAV may fly completely based on the received user input or fly based on the combination of the received user input and one or more flight control instructions generated from the autonomous flight.

In some scenarios, when flying within the operational area, the UAV may encounter one or more obstacles, such as the obstacle 710 present along the flight trajectory 706 as illustrated. In this case, in accordance with the first set of control rules, the flight of the UAV may be controlled by the user via a remote controller, such as the remote controller 708 illustrated in FIG. 7. Based on the manual control from the user, one or more processors of the UAV may be configured to permit the UAV to deviate from the flight trajectory to avoid the obstacle while still flying within the operational area.

When deviating from the flight trajectory and still flying within the operational area, the UAV may be configured to automatically fly back to the flight trajectory based on the first set of control rules. For example, after the user manually controls the UAV to deviate from the flight trajectory, the UAV may automatically fly back to the flight trajectory when no user input is received, for example, within a given period of time. In this case, the UAV may switch from the semi-autonomous mode or manually-controlled mode to the autonomous mode. In some embodiments, the UAV, when manually flying within the operational area, may be able to switch to autonomous flight upon user release of the control sticks of the remote controller.

In some scenarios, after avoiding the obstacle or completing a given flight task, the UAV may significantly deviate from the flight trajectory and thereby may fly outside the operational area, i.e., into a non-operational area. Under this situation, the flight of the UAV may be controlled by the user via the remote controller in accordance with the second set of control rules, i.e., the UAV being manually controlled. For example, the user may manually control the UAV to fly outside the operational area until the obstacle is completely avoided. In some instances, in addition to the obstacle, the UAV may encounter a restricted fly zone and thereby avoiding such a restricted fly zone may cause the UAV to significantly deviate from the flight trajectory and enter into the non-operational area. Under this situation, the UAV may be controlled by the user via the remote controller in accordance with the second set of control rules, until, for example, the UAV completely flies across this restricted area.

In some instances, an obstacle, a restricted area, an area with extreme weather, or the like along a flight trajectory can be detected by one or more sensors on-board a UAV, such as obstacle sensors, proximity sensors, position sensors (including global positioning system sensors), temperature sensors, barometers, altimeters or the like. For example, by collecting various kinds of sensitive data with aid of numerous sensors, one or more processors of the UAV may be able to determine whether deviation from the flight trajectory is necessary. If this is the case, the one or more processors may generate one or more autonomous flight instructions to change one or more flight parameters of the UAV in the autonomous mode. In some instances, if the deviation is not significant, the UAV would still fly autonomously within the operational area in accordance with a first set of control rules. However, in some instances, if the deviation is significant, which results in the UAV flying outside the operational area, the second set of control rules may become effective and the UAV may be manually controlled to fly outside the operational area. In some instances, the UAV may be able to prompt the user about its exit from the operational area. For example, the UAV may transmit an indication signal to the remote controller with aid of one or more transmitters, indicating to the user that the UAV is about to leave the operational area and enter into the non-operational area, and therefore, that a second set of control rules which is different from a first set of control rules may become effective. At the ground side, as an example, the received indication signal may be converted as flashing of an indicator on the remote controller or a pop-up window displayed on a display device connected to the remote controller, reminding the user of UAV entering into a non-operational area.

When a UAV is outside an operational area, i.e., entering into the non-operational area, as exemplarily shown in FIG. 7, a remote user may be able to manually control the flight via a remote controller. For example, the user may manually control a flight direction, an orientation, acceleration of the UAV. Further, when one or more obstacles appear in the non-operational area, the user may manually control the UAV to avoid the obstacles, making the flight much safer. When conducting aerial photography, the user may be able to control an image capture device coupled to a carrier (e.g., a gimbal) supported by the UAV. For example, by manipulating control sticks or pressing buttons on the remote controller, the user may be able to control rotation of the gimbal around different axes, such as a pitch axis, a yaw axis, and a raw axis relative to a central body of the UAV. Therefore, the user may be able to adjust shooting angles of the image capture device, for example, for high-angle shot or low-angle shot. In some instances, since the UAV is outside the operational area, it may be inappropriate for the UAV to accomplish a given task associated with the flight. Therefore, a UAV may be configured to cease a flight task associated with a flight trajectory when the UAV is outside the operational area.

In some instances, the UAV may reenter into the operational area from outside. To this end, the UAV may be configured to check its proximity with the operational area when the UAV is outside the operational area. For example, the UAV may be configured to determine its distance to the operational area or determine whether it is about to be in the operational area based on the proximity. In some implementations, the UAV may be configured to transmit a signal indicative of the proximity to the remote controller, e.g., in real-time or periodically. Thereby, the user may learn about how far the UAV is away from the operational area and may further decide whether or not make the UAV fly in the operational area again.

Upon a determination of reentering into the operational area, one or more processors of the UAV may be configured to generate one or more flight control signals to permit the UAV to fly back to the operational area from outside the operational area. For example, a remote controller remotely controlling the UAV may receive a user input via a user interface for instructing the UAV to fly back to the operational area. After converting the user input into one or more user instructions, the remote controller may transmit the user instructions to the UAV in the air. Upon receipt of the user instructions by one or more receivers of the UAV, one or more processors of the UAV may generate corresponding flight instructions to cause the UAV to reenter into the operational area. Alternatively, the flight of the UAV back to the operational area may be effected with aid of one or more sensors on-board the UAV. As described above, the one or more sensors may collect various types of data necessary for determining whether or not to reenter into the operational area. Upon a determination of reentry into the operational area, the UAV may autonomously or semi-autonomously fly back to the operational area. As an optional, before autonomously or semi-autonomously flying back to the operational area, the UAV may automatically send an alerting signal to the user via one or more transmitters, altering the user that the UAV is about to fly back into the operational area. In this situation, the user may confirm correspondingly. As an alternative, the alerting signal is only for alerting the user but does not require any confirmation from the user. In some embodiments, the altering signal herein may include distance information about the distance between the UAV and an edge of the operational area.

The UAV may take different paths or routes to fly back to the operational area. For example, the UAV may be guided by the user to manually fly back to the operational area in a random or arbitrary path. In some instances, when the UAV enters into the autonomous mode for reentering into the operational area, it may take a shortest path to get back to the operational area, such as the one 304 exemplarily illustrated in FIG. 3. Alternatively, the UAV may progressively smoothly fly back to the operational area in the autonomous mode along a curved path, such as the one 302 exemplarily illustrated in FIG. 3. Additionally, the UAV may fly autonomously back to the operational area along a path specified by the user, such as the one 306 exemplarily illustrated in FIG. 3.

In some embodiments, an operational area may be generated during a flight of the UAV. The generation of the operational area may be responsive to one or more conditions. For example, an operation area may be generated in response to one or more obstacles along a flight trajectory. Further, an operational area may be generated in response to one or more restricted areas along the flight trajectory. As a further example, an operational area may be generated in response to one or more area with extreme weather along the flight trajectory. A person skilled in the art can envisage any other conditions that may force the UAV to deviate the flight trajectory and for which an operational area will be generated.

Unlike an operational area that is planned prior to the flight of the UAV, an operational area generated during the flight of the UAV may have a specific size or shape, in addition to taking into account the flight trajectory. In some embodiments, an operational area generated in response to an obstacle may have a size or shape that comprises or encompasses the obstacle. The operational areas generated in this way have different sizes, such as the ones 722 and 724 shown in dashed boxes of FIG. 7, which can be selected or set by the user before or during the flight. For example, the user may select either type of the operational areas prior to the flight, i.e., one type that is closely encompassing the obstacle such as shown at 724 or one type that is encompassing the obstacle and UAV together such as shown at 722. In some instances, the generated operational area during the flight of the UAV may be extended to a limited distance or to a destination from the position where the operational area has been generated.

When the operational area has been generated during the flight of the UAV, one or more processors of the UAV may be configured to permit the UAV to fly in accordance with a first set of control rules when the UAV is in the operational area and permit the UAV to fly in accordance with a second set of control rules when the UAV is outside the operational area.

Take the operational area generated in response to the obstacle as an example, in some embodiments in which the operational area may encompass both the UAV and the obstacle, one or more processors of the UAV may be configured to permit the UAV to fly autonomously in accordance with the first set of control rules and avoid the obstacle automatically without any user input from the user. After avoiding the obstacle and thereby deviating from the flight trajectory, the UAV may autonomously fly back to the flight trajectory, for example, via a shortest path, a progressively smooth path, or a specified path as discussed before with respect to FIG. 3. When the UAV is flying autonomously within the generated operational area in accordance with the first set of control rules, the user may still be able to amend one or more flight parameters of the UAV without causing the UAV to exit from the autonomous mode. In this case, the user instruction including the amendments to the flight parameters may be added to the flight parameters generated from the autonomous flight of the UAV.

In some embodiments in which the generated operational area may only encompass or cover the obstacle, one or more processors of the UAV may be configured to permit the UAV to fly in accordance with the second set of control rules. For example, the one or more processors of the UAV may be configured to permit the UAV to be manually controlled to fly over the obstacle. In this case, the user may manipulate the control sticks disposed on the remote controller to avoid the obstacle. Having successfully avoided the obstacle, the UAV may be permitted to fly back to the operational area, for example, based on the user input from the remote controller. In this case, the user may manually control the UAV to fly back to the generated operation area in one of many possible manners as discussed before. During the flight of the UAV back to the operational area, an alerting signal as discussed above may be transmitted to the remote controller, informing the user of returning of the UAV. Once the UAV flies back into the generated operational area, the second set of control rules may become invalid and the first set of control rules may become valid. Thereafter, one or more processors of the UAV may be configured to permit the UAV to fly autonomously or semi-autonomously within the operational area.

In some embodiments, the generated operational area may be set a period of validity. The period of validity may be set as a given period of time or a given distance that the UAV travel through. In cases when the period of validity is set as a given period of time, the UAV may be completely in the autonomous flight or completely in the manually-controlled flight when the given period of time expires. Alternatively, the UAV may be in the semi-autonomous flight after the given period of time.

It can be seen from the above descriptions that a UAV can fly autonomously or semi-autonomously in accordance with a first set of control rules when it is within an operational area, and that the UAV can be manually controlled to fly in accordance with a second set of control rules when it is outside the operational area. Further, it can be envisaged by those skilled in the art that, in some embodiments, a UAV can be manually controlled to fly in accordance with a first set of control rules when it is within an operational area, and that the UAV can fly autonomously or semi-autonomously in accordance with a second set of control rules when it is outside the operational area. In other words, the first set of control rules and the second set of control rules may be interchangeable in some situations.

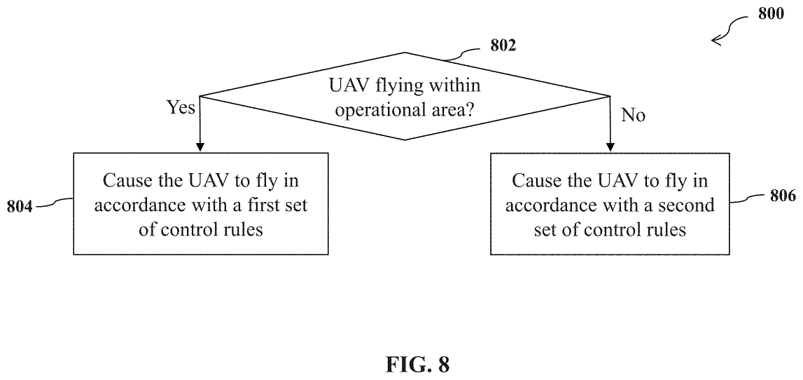

FIG. 8 shows a flow of a method 800 for controlling flight of a UAV, in accordance with embodiments of the disclosure. It is to be understood that the UAV as discussed herein may be identical or similar to (or share one or more characteristics with) those as discussed before with respect to any of FIGS. 1-7. Therefore, any description of the UAV as made before may apply to the UAV as discussed herein. Further, it is to be understood that the method herein may be implemented between the UAV and the remote controller so as to control the UAV in different areas, i.e., an operational area and non-operational area, such as those illustrated and discussed with respect to FIG. 7. Thus, any descriptions of the operational area and non-operational area with reference to FIG. 7 made above may equally apply to the operational area and non-operational area as discussed hereinafter.

As illustrated in FIG. 8, at 802, the method may detect whether a UAV is flying within an operational area. When the UAV is detected to be within the operational area, then at 804, the method may effect a flight of the UAV, with aid of one or more propulsion units, in accordance with a first set of control rules, i.e., cause the UAV to fly in accordance with the first set of control rules. Additionally or alternatively, when the UAV is detected to be outside the operational area, then at 806, the method may effect the flight of the UAV, with aid of the one or more propulsion units, in accordance with a second set of control rules, i.e., cause the UAV to fly in accordance with the second set of control rules. The operational area may be defined with respect to a flight trajectory.

In some instances, the first set of control rules and second set of control rules may be different. For example, the first set of control rules and the second set of control rules may differ in controlling the UAV, e.g., different sources, different degrees of autonomy, different responsiveness, and different restrictions/regulations. As an example, the first set of control rules may be related to or affect an autonomous flight of the UAV and the second set of the control rules may be related to or affect semi-autonomous flight of the UAV. As a further example, the first set of control rules may be related to or affect an autonomous flight of the UAV and the second set of the control rules may be related to or affect manually-controlled flight of the UAV. The first set of control rules and the second set of control rules may be interchangeable in some embodiments. For instance, the first set of control rules may be related to or affect the semi-autonomous or manually-controlled flight of the UAV and the second set of control rules may be related to or affect the autonomous flight of the UAV.

In some instances, when the first set of control rules is applied for autonomous flight, the UAV, after taking off from a source, may autonomously fly along a flight trajectory within an operational area. During the autonomous flight, the UAV may execute one or more pre-programmed instructions to ensure a proper flight in the air. For instance, autonomous flight instructions may be generated by one or more processors of the UAV and transmitted to corresponding units for execution, e.g., transmitting to the flight controller of the UAV to adjust the flight direction or orientation, flight speed or output power, etc. When an obstacle is detected, an autonomous obstacle avoidance procedure may be performed to deviate from the flight trajectory and avoid the obstacle. In some instances, when the second set of control rules is applied for manually-controlled flight, the flight of the UAV is solely based on the manual operations of the user. For example, the user may manipulate the remote controller and the user input may be transmitted wirelessly to the UAV. Upon receipt of the user input, the UAV may operate completely based on the user input. For example, the UAV may be manually controlled to fly towards a given target, to avoid an obstacle, or to return back to the operational area when it is outside the operational area.

The detection of the whether the UAV is flying within the operational area may be performed in accordance with at least one of the first set of control rules and the second set of control rules. For example, in accordance with the first set of control rules, the UAV may self-determine whether it is within the operational area, for example, with aid of one or more sensors on-board the UAV. Alternatively, in accordance with the second set of control rules, the user may observe a screen which shows graphic representations of the UAV and the operational area, and determine whether the UAV is within the operational area. In some situations, the user observation or user input may be combined with the UAV's self-determination so as to detect whether the UAV is within the operational area.

The operational area herein may be generated in response to user input, for example, when planning the flight trajectory of the UAV. Alternatively, the operational area is generated in response to a detection of an obstacle along the flight trajectory followed by the UAV and the operational area generated in this way may cover or encompass the obstacle or both the obstacle and the UAV. The operational area may be form a three dimensional spatial space. As an example, the operational area is generated as an area with fully enclosed or partially enclosed boundaries. As another example, the operational area may be a cylinder and the flight trajectory may be a central axis of the cylinder. The flight trajectory may be configured to be within the operational area. In some instances, the flight trajectory may be planned without regard to presence of one or more obstacles along the flight trajectory.

In some embodiments, when the UAV is within the operational area, the method may cause the UAV to fly autonomously or semi-autonomously following the flight trajectory in accordance with the first set of control rules. To follow the flight trajectory, one or more of a plurality of conditions may be met, including but not limited to one or more of absence of an obstacle along the flight trajectory, absence of an undesirable environmental factor within the operational area, and absence of a restricted area within the operational area. In some instances, when the UAV is outside the operational area, the method may cause the UAV to be controlled by a user via a remote controller. Conversely, when the UAV is within the operational area, the method may cause the UAV to be controlled by a user via a remote controller, and when the UAV is outside the operational area, the method may cause the UAV to fly autonomously or semi-autonomously. When flying semi-autonomously outside the operational area, the autonomous flight instructions generated on-board the UAV may be combined with the user input from the remote controller while the UAV is still autonomously along the flight trajectory.

The operational area may remain unchanged during the flight of the UAV in accordance with the first set of control rules. Alternatively, the operational area may be changed during the flight of the UAV along the flight trajectory in accordance with the first set of control rules. For example, the operational area may be stretched or enlarged to encompass the UAV so that the UAV would still fly in accordance with the first set of control rules.

In some instances, the method may cause the UAV to deviate from the flight trajectory to avoid one or more obstacles along the flight trajectory in accordance with the first set of control rules within the operational area. In some instances, when the UAV deviates from the flight trajectory to be outside the operational area, the method may cause the UAV to fly in accordance with the second set of control rules, for example, in a non-autonomous mode. In this case, the user may manually control the UAV to fly outside the operational area and may instruct the UAV to fly back into the operational area, for example, via a shortest path, a specified path or a progressively smooth path.

To effect the flight operations of the UAV in the operational area and non-operational area, a remote controller is introduced in accordance with the disclosure. The remote controller may comprise a user interface configured to receive user input from a user and a communication unit configured to transmit, while the UAV is in flight, an instruction for the UAV to fly based on the user input with aid of one or more propulsion units, wherein the user input effects (1) flight of the UAV in accordance with a first set of control rules, when the UAV is within an operational area, and (2) flight of the UAV in accordance with a second set of control rules different from the first set of control rules, when the UAV is outside the operational area, wherein the operational area is defined with respect to a flight trajectory.

The remote controller as mentioned above may receive the user input and work with the UAV to accomplish configuration, operations and controlling as discussed above with reference to FIGS. 6-8. Therefore, any descriptions of the remote controller as made above may also apply to the remote controller as discussed herein.

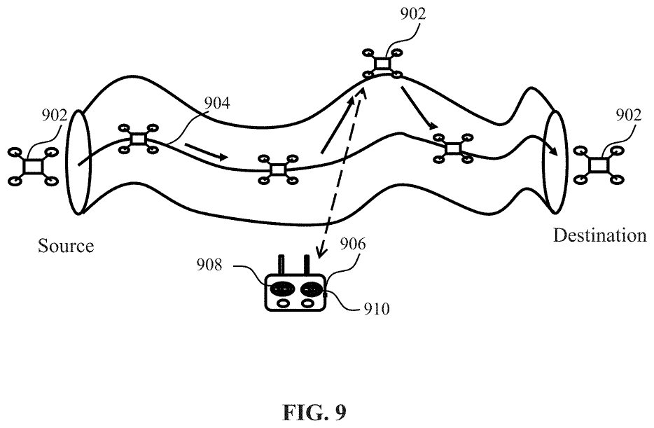

FIG. 9 provides an illustration of an autonomous flight of a UAV 902 with or without manual control, in accordance with embodiments of the disclosure. It is to be understood that the UAV 902 herein may be identical or similar to (or share one or more characteristics with) the one discussed before with respect to FIG. 1. Therefore, any description of the UAV as made before may equally apply to the UAV as discussed below.

As illustrated in FIG. 9, the UAV may fly from a source to a destination, e.g., along a flight trajectory 904, with aid of one or more propulsion units, which may generate lift to effect the flight of the UAV. During the flight of the UAV, depending on whether one or more conditions are met, one or more processors of the UAV may be configured to: 1) permit the UAV to fly completely based on the user input when the user input is received by one or more receivers of the UAV, and 2) permit the UAV to fly based on one or more autonomous flight instructions generated on-board the UAV or a combination of the user input and the one or more autonomous flight instructions. It can be understood, based on the descriptions made before, that 1) flying completely based on the user input means the UAV is flying in a manually-controlled mode, 2) flying based on the autonomous flight instructions generated on-board the UAV means that the UAV is flying in an autonomous mode, and 3) flying based on the combination of the user input and the autonomous flight instructions generated on-board the UAV means that the UAV is flying in a semi-autonomous mode.

In some embodiments, the one or more conditions as mentioned above may comprise presence or absence of the UAV within an operational area. The operational area herein may be identical or similar to (or share one or more characteristics with) those as discussed before with respect to FIGS. 6 and 7, and therefore any description of the operational area as made with respect to FIGS. 6 and 7 may equally apply to the operational area as discussed herein. For example, the operational area may be defined with respect to a flight trajectory followed by the UAV in the autonomous flight. In some instances, one or more parameters of the operational area may be determined in response to the user input when planning the flight trajectory of the UAV. In other words, a shape, a size, continuity, or the like of the operational area may be set by a user taking into account the planned flight trajectory, which may be planned to be within the operational area. Alternatively, the operational area may be generated in response to a detection of an obstacle along the flight trajectory followed by the UAV and the operational area may comprise the obstacle.

Additionally, the one or more conditions may also comprise a flight state of a UAV. In some instances, the flight state of the UAV may comprise one or more of states of one or more propulsion units, states of one or more battery units, states of one or more on-board sensors, states of one or more carriers supported by the UAV, states of one or more payloads coupled to the UAV. It should be noted that any other states of units, systems, components, assemblies, or the like of the UAV can also be envisaged by those skilled in the art.

The user input herein may be implemented by a remote controller 906 as illustrated in FIG. 9. The user input may include various kinds of instructions that may be received by the remote controller and can be executed by one or more processors of the UAV to effect the flight of the UAV. The user input may be able to cause the UAV to change its one or more flight parameters or help the UAV to perform various kinds of operations, such as avoiding one or more obstacles along a flight trajectory as noted before.

In some embodiments, the user input may comprise one or more control components generated via the remote controller. To this end, the remote controller may comprise one or more actuatable mechanisms for generating the one or more control components. The actuatable mechanisms may comprise buttons, knobs, joysticks, sliders, or keys. The user input may also be implemented via a display device connected to or integrated with the remote controller. A user interface, such as a graphic user interface may be displayed on the display device. The graphic user interface may comprise a plurality of graphic items for user selections or user settings. For example, the graphic items may comprise a plurality of entry items for user input of desirable flight parameters, such as the flight speed, the flight orientation, the flight height. In some embodiments, the plurality of entry items may comprise entry items for setting the size, the shape, the continuity or the like of an operational area as discussed before. Additionally, the plurality of entry items may comprise entry items for setting a flight trajectory to be taken by the UAV, for example, a source, a destination, a shape, a size (such as a display size) of the flight trajectory, with or without taking into account one or more obstacles possibly present along the flight trajectory.

In some embodiments, the one or more actuatable mechanisms may comprise one or more control sticks, such as the control sticks 908 and 910 as illustrated in FIG. 9. In some instances, an actuation of the one or more control sticks may be configured to generate the one or more control components. The one or more control components herein may comprise one or more of a velocity component, a direction component, a rotation component, an acceleration component. In some instances, the combination of the user input and the one or more autonomous flight instructions may comprise adding the one or more control components generated by the actuation of the one or more control sticks to one or more corresponding autonomous control components in the autonomous flight instructions.

In some implementations, control sticks may be designated with certain names (e.g., pitch stick, yaw stick, etc), it is to be understood that the designations of the control sticks are arbitrary. For example, a remote controller or a display device connected to the remote controller may be able operate under different modes. For example, the remote controller or the display device may operate under different modes with a given command from a user, e.g., actuation of a switch. Under different modes, an actuation mechanism may be configured to affect operation of the UAV in different ways. In some instances, in one operating mode, an actuation mechanism may be configured to effect autonomous flight, while in another operating mode, an actuation mechanism may be configured to affect the flight of the UAV under the autonomous flight.

In some instances, in a first mode, a control stick may be configured to affect a forward and backward movement of the UAV, while in a second mode, the control stick may be configured to affect a velocity of the UAV moving in a forward direction. In a third operating mode, the control stick may be configured to affect a height of the UAV and/or a rotation of the UAV about one or more axes. The remote controller or the display device may comprise one, two, three, four, five or more operating modes. In addition, a given control stick may comprise more than one functionality, or may affect a flight (e.g., autonomous flight) of the UAV in more than one parameter. For example, a control stick moving forward and backward may affect a change in height of the of a UAV while the control stick moving left and right may affect rotation of a UAV about a roll axis.

In some embodiments, the user input may help to avoid one or more obstacles along a flight trajectory. As noted before, the user input can be received by a remote controller, which is capable of remotely controlling the UAV, and based on the received the user input, the remote controller may be able to send user instructions to one or more receivers of the UAV. Then, upon receipt of the user instructions, one or more processors of the UAV may be configured to permit the UAV to change one or more of a flight speed, a flight direction, flight orientation or a flight height so as to avoid the obstacle.

In a situation where the operational area is generated in response to user input (e.g., when planning a flight trajectory of the UAV), the one or more processors of the UAV may be configured to permit the UAV to fly based on the one or more autonomous flight instructions or based on a combination of the user input and the one or more autonomous flight instructions, when the UAV is within the operational area. Here, the UAV being within the operational area is a condition for operating the UAV in an autonomous node or in a semi-autonomous mode. For example, when the UAV is within the operational area, the user does not need to provide any user input but the UAV itself is autonomously flying based on various kinds of the data that it collects, decisions it makes and autonomous flight instructions it generates with aid of one or more processors. Alternatively, even in the autonomous flight, the user may also provide user input to affect the flight of the UAV. As noted before, the user may change or amend one or more flight parameters of the UAV by adding flight instructions to the autonomous flight instructions generated on-board the UAV, thereby combining the user input with the autonomous flight instructions. In this case, the UAV may fly in a semi-autonomous mode and may be much safer since the user intervention is involved. In some scenarios, the UAV may be permitted to perform a seamless or smooth switch between the autonomous flight and the semi-autonomous flight based on whether the user input is received. In particular, when flying autonomously in the air, the UAV may be switched to the semi-autonomous flight after receiving the user input with aid of one or more receivers. In contrast, when flying in the semi-autonomous flight with aid of the user input, the UAV may be switched to the autonomous flight when the user input is not received, for example, the user releasing the control sticks or selecting the autonomous mode.

Conversely, when the UAV is outside the operational area, one or more processors of the UAV may be configured to permit the UAV to fly completely based on the user input. Here, the UAV being outside the operational area is a condition for operating the UAV in a manually-controlled mode. Since the UAV now is outside the operational area, the UAV would only rely on the user input to fly in the air. For example, the user may provide any kinds of user input as discussed previously via a remote controller, which may optionally convert them into corresponding user instructions and transmit these user instructions wirelessly to the UAV. Upon receiving the user instructions by one or more receivers of the UAV, one or more processors may optionally convert these user instructions into flight controller instructions and execute them accordingly. For example, the one or more processors may instruct a flight controller on-board the UAV to control rotation speeds or rotation directions of one or more blades of the one or more propulsion units based on the flight controller instructions. In this manner, the UAV may be controlled by the user via the remote controller while disabling or disregarding any autonomous flight instructions generated within the operational area.

In a situation where the operational area is generated in response to a detection of an obstacle along the flight trajectory followed by the UAV and the operational area encompasses the obstacle, when the UAV is within the operational area, one or more processors of the UAV may be configured to permit the UAV to fly completely based on the user input. Similar to what is described above, in this case, the user input is the only control source for controlling the flight of the UAV while the autonomous flight instructions generated by the UAV are completely ignored. In this way, the user may be able to manually control the UAV to avoid the obstacle along the flight trajectory. In contrast, when the UAV is outside the operational area, the one or more processors of the UAV may be configured to permit the UAV to fly based on a combination of the user input and the one or more autonomous flight instructions when the UAV is outside the operational area. In other words, in this case, the UAV may be operating in a semi-autonomous mode in which the UAV may still be flying autonomously while receiving and accepting the flight changes or modifications made the user via the remote controller. It may be convenient sometimes since the user still has a certain control in the autonomous flight of the UAV, and timely and proper adjustments to the autonomous flight may be necessary in some situations.

In some embodiments in which the one or more conditions comprise the flight state of the UAV, as noted above. A flight safety level may be obtained based on the flight state of the UAV. For example, by taking into account the one or more of states of one or more propulsion units, states of one or more battery units, states of one or more onboard sensors, states of one or more carriers supported by the UAV, states of one or more payloads coupled to the UAV, the user may be able to determine whether the user input is necessary or needed for the current flight of the UAV, or what degree the safety of the UAV's flight is. In some implementations, the user may give different weights to different units on-board the UAV, for example, assigning a relatively heavy weight to the propulsion units or battery units, assigning a less heavy weight to the on-board sensors, and assign a least heavy weight to the carriers, and once the states of these units are available, the user may average or sum these weighted states to obtain a flight safety level, which may be used as a condition for deciding how to control the UAV during the flight.

In some instances, when the flight safety level indicates that user input is not needed for the flight of the UAV, one or more processors of the UAV may be configured to permit the UAV to fly based on the user input and the one or more autonomous flight instructions generated on-board the UAV. Therefore, the UAV may be operating in the semi-autonomous mode. In contrast, when the flight safety level indicates that the user input is needed for the flight of the UAV, the one or more processors of the UAV may be configured to permit the UAV to fly completely based on the user input. In other words, the UAV is operating in the manually-controlled mode. This is convenient and sometimes may be necessary since the user input would be highly expected when the flight of the UAV is not stable or very safe. For example, when the power level provided by the battery units becomes low and thus the UAV cannot arrive at a given destination, a timely user input is needed to control the UAV to abort the given task, return back to the source, or land immediately.

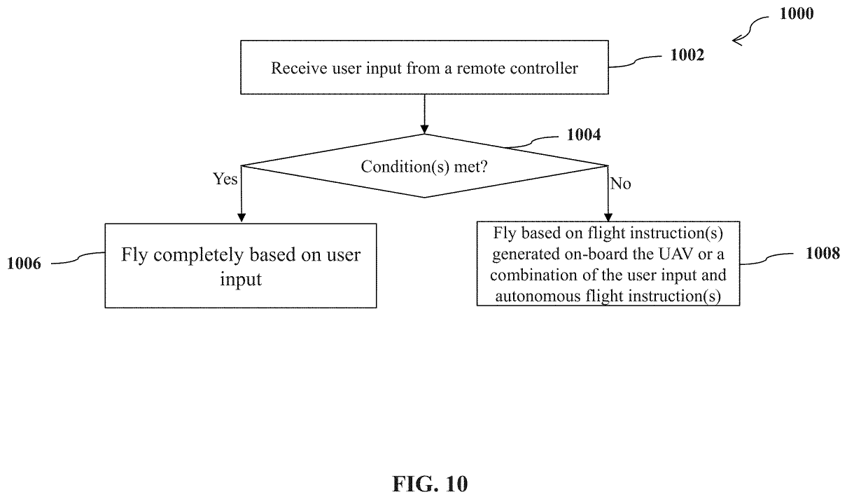

FIG. 10 shows a flow chart of a method 1000 for controlling operation of a UAV, in accordance with embodiments of the disclosure. It is to be understood that the UAV and the remote controller discussed herein may be identical or similar to (or share one or more characteristics with) the one as shown and discussed before with respect to FIG. 1. Therefore, any description of the UAV and remote controller as discussed previously may equally apply to the UAV and remote controller as discussed below.

As illustrated in FIG. 10, at 1002, the method may receive a user input from a remote controller which may remotely control the UAV. The user input may comprise various types of input as discussed above. Then, at 1004, the method may determine whether one or more conditions are met. As discussed above with respect to FIG. 9, the one or more conditions may comprise presence or absence within the operational area, or the flight safety level. If one or more conditions are met, then at 1006, the method may permit the UAV to fly completely based on the user input. In this case, the condition may be that the UAV is outside the operational area when the operational area is generated in response to the user input when planning a flight trajectory. Alternatively, the condition may be that the flight safety level indicates that user input is needed for the flight of the UAV. Conversely, when these conditions are not met, then at 1008, the method may permit the UAV to fly based on autonomous flight instructions generated on-board the UAV or based on a combination of the user input and the autonomous flight instructions. For example, when the UAV is in the operational area, then the method may permit the UAV to fly autonomously or semi-autonomously with the combination of the user input and the autonomous flight instructions.

In some embodiment, in order to control the UAV, a remote controller is accordingly provided. The remote controller may comprise a user interface configured to receive user input from a user and a communication unit configured to transmit the user input to the UAV, such that the UAV is permitted to fly: (1) completely based on the user input when the user input is received by the UAV, and (2) fly based on a combination of the user input and one or more autonomous flight instructions generated by on-board the UAV, when one or more conditions are met.

As noted before, the one or more conditions comprise presence or absence of the UAV within an operational area, which, in some embodiments, may be generated in response to user input, for example, when planning a flight trajectory of the UAV and, in some embodiments, may be generated in response to a detection of an obstacle along the flight trajectory followed by the UAV and the operational area encompasses the obstacle. The condition may also comprise a flight state of the UAV, whose safety may be indicated by a flight safety level. Based on these conditions, the remote controller may control the UAV to fly autonomously or semi-autonomously along a flight trajectory.

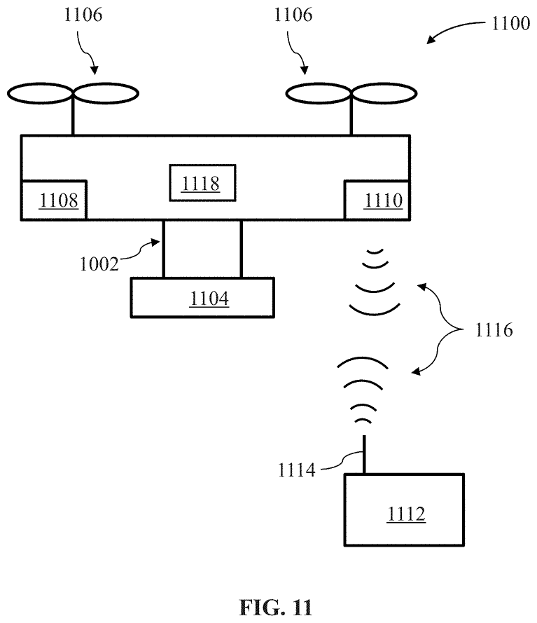

FIG. 11 illustrates a movable object 1100 including a carrier 1102 and a payload 1104, in accordance with embodiments. Although the movable object 1100 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., a UAV). In some instances, the payload 1104 may be provided on the movable object 1100 without requiring the carrier 1102. The movable object 1100 may include propulsion mechanisms 1106, a sensing system 1108, and a communication system 1110.

The propulsion mechanisms 1106 can include one or more of rotors, propellers, blades, engines, motors, wheels, axles, magnets, or nozzles, as previously described. For example, the propulsion mechanisms 1106 may be self-tightening rotors, rotor assemblies, or other rotary propulsion units, as disclosed elsewhere herein. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1106 can be mounted on the movable object 1100 using any suitable means, such as a support element (e.g., a drive shaft) as described elsewhere in this specification. The propulsion mechanisms 1106 can be mounted on any suitable portion of the movable object 1100, such on the top, bottom, front, back, sides, or suitable combinations thereof.

In some embodiments, the propulsion mechanisms 1106 can enable the movable object 1100 to take off vertically from a surface or land vertically on a surface without requiring any horizontal movement of the movable object 1100 (e.g., without traveling down a runway). Optionally, the propulsion mechanisms 1106 can be operable to permit the movable object 1100 to hover in the air at a specified position and/or orientation. One or more of the propulsion mechanisms 1106 may be controlled independently of the other propulsion mechanisms. Alternatively, the propulsion mechanisms 1106 can be configured to be controlled simultaneously. For example, the movable object 1100 can have multiple horizontally oriented rotors that can provide lift and/or thrust to the movable object. The multiple horizontally oriented rotors can be actuated to provide vertical takeoff, vertical landing, and hovering capabilities to the movable object 1100. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 1100 (e.g., with respect to up to three degrees of translation and up to three degrees of rotation).

The sensing system 1108 can include one or more sensors that may sense the spatial disposition, velocity, and/or acceleration of the movable object 1100 (e.g., with respect to up to three degrees of translation and up to three degrees of rotation). The one or more sensors can include global positioning system (GPS) sensors, motion sensors, inertial sensors, proximity sensors, obstacle sensors or image sensors. The sensing data provided by the sensing system 1108 can be used to control the spatial disposition, velocity, and/or orientation of the movable object 1100 (e.g., using a suitable processing unit and/or control module, as described below). Alternatively, the sensing system 1108 can be used to provide data regarding the environment surrounding the movable object, such as weather conditions, proximity to potential obstacles, location of geographical features, location of manmade structures, and the like. In some embodiments, the obstacle avoidance operations as discussed before may be accomplished, based on the data collected by the sensing system 1108.

The communication system 1110 enables communication with terminal 1112 having a communication system 1114 via wireless signals 1116. The communication systems 1110, 1114 may include any number of transmitters, receivers, and/or transceivers suitable for wireless communication. The communication may be one-way communication, such that data can be transmitted in only one direction. For example, one-way communication may involve only the movable object 1100 transmitting data to the terminal 1112, or vice-versa. The data may be transmitted from one or more transmitters of the communication system 1110 to one or more receivers of the communication system 1112, or vice-versa. Alternatively, the communication may be two-way communication, such that data can be transmitted in both directions between the movable object 1100 and the terminal 1112. The two-way communication can involve transmitting data from one or more transmitters of the communication system 1110 to one or more receivers of the communication system 1114, and vice-versa.

In some embodiments, the terminal 1112 can provide control data to one or more of the movable object 1100, carrier 1102, and payload 1104 and receive information from one or more of the movable object 1100, carrier 1102, and payload 1104 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 1106), or a movement of the payload with respect to the movable object (e.g., via control of the carrier 1102). The control data from the terminal may result in control of the payload, such as control of the operation of a camera or other image capture device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 1108 or of the payload 1104). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 1112 can be configured to control a state of one or more of the movable object 1100, carrier 1102, or payload 1104. Alternatively or in combination, the carrier 1102 and payload 1104 can also each include a communication module configured to communicate with terminal 1112, such that the terminal can communicate with and control each of the movable object 1100, carrier 1102, and payload 1104 independently.

In some embodiments, the terminal 1112 may include a user interaction apparatus as discussed before for interacting with the movable object 1100. For example, with aid of the user interaction apparatus, the terminal 1112 may receive a user input to initiate mode switching of the movable object 1100 from an autonomous mode to a semi-autonomous mode or a manually-controlled mode, thereby improving the usability and controllability of the moveable object 1100.

In some embodiments, the movable object 1100 can be configured to communicate with another remote device in addition to the terminal 1112, or instead of the terminal 1112. The terminal 1112 may also be configured to communicate with another remote device as well as the movable object 1100. For example, the movable object 1100 and/or terminal 1112 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 1100, receive data from the movable object 1100, transmit data to the terminal 1112, and/or receive data from the terminal 1112. Optionally, the remote device can be connected to the Internet or other telecommunications network, such that data received from the movable object 1100 and/or terminal 1112 can be uploaded to a website or server.

According to the embodiments of the disclosure, the movable object 1100 may be of different modes, such as those discussed before or elsewhere in this specification. When the moveable object 1100 supports different modes, it may be operating in any of different modes as discussed before and may be capable of transforming between a mode (e.g., autonomous mode) and another mode (e.g., semi-autonomous mode or manually-controlled mode).

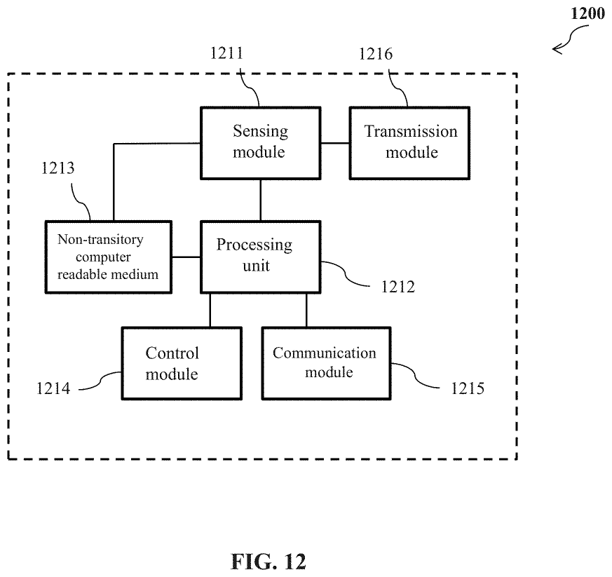

FIG. 12 is a schematic illustration by way of block diagram of a system 1200 for controlling a movable object, in accordance with embodiments. The system 1200 can be used in combination with any suitable embodiment of the systems, devices, and methods disclosed herein. The system 1200 can include a sensing module 1211, processing unit 1212, non-transitory computer readable medium 1213, control module 1214, communication module 1215 and transmission module 1216.

The sensing module 1211 can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module 1211 can be operatively coupled to a processing unit 1212 having a plurality of processors. In some embodiments, the sensing module can be operatively coupled to a transmission module 1216 (e.g., a Wi-Fi image transmission module) configured to directly transmit sensing data to a suitable external device or system. For example, the transmission module 1216 can be used to transmit images captured by a camera of the sensing module 1211 to a remote terminal.

The processing unit 1212 can have one or more processors, such as a programmable processor (e.g., a central processing unit (CPU)). The processing unit 1212 can be operatively coupled to a non-transitory computer readable medium 1213. The non-transitory computer readable medium 1213 can store logic, code, and/or program instructions executable by the processing unit 1204 for performing one or more steps or functions as necessary for the operations of the system 1200. The non-transitory computer readable medium can include one or more memory units (e.g., removable media or external storage such as an SD card or random access memory (RAM)). In some embodiments, data from the sensing module 1211 can be directly conveyed to and stored within the memory units of the non-transitory computer readable medium 1213. The memory units of the non-transitory computer readable medium 1213 can store logic, code and/or program instructions executable by the processing unit 1212 to perform any suitable embodiment of the methods described herein. For example, the processing unit 1212 can be configured to execute instructions causing one or more processors of the processing unit 1212 to analyze sensing data produced by the sensing module and change configurations or modes of the movable object. The memory units can store sensing data from the sensing module to be processed by the processing unit 1212. In some embodiments, the memory units of the non-transitory computer readable medium 1213 can be used to store the processing results produced by the processing unit 1212.

In some embodiments, the processing unit 1212 can be operatively coupled to a control module 1214 configured to control a state or mode of the movable object. For instance, the control module 1214 can be configured to control the propulsion mechanisms of the movable object to adjust the spatial disposition, velocity, and/or acceleration of the movable object with respect to six degrees of freedom. Alternatively or in combination, the control module 1214 can control one or more of a state of one or more functional units including but not limited to a carrier, payload, or sensing module.

The processing unit 1212 can be operatively coupled to a communication module 1215 configured to transmit and/or receive data from one or more external devices (e.g., a terminal, display device, or other remote controller). Any suitable means of communication can be used, such as wired communication or wireless communication. For example, the communication module 1215 can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 1215 can transmit and/or receive one or more of sensing data from the sensing module 1211, processing results produced by the processing unit 1212, predetermined control data, user commands from a terminal or remote controller, and the like.

The components of the system 1200 can be arranged in any suitable configuration. For example, one or more of the components of the system 1200 can be located on the movable object, carrier, payload, terminal, sensing system, or an additional external device in communication with one or more of the above. Additionally, although FIG. 12 depicts a single processing unit 1212 and a single non-transitory computer readable medium 1213, one of skill in the art would appreciate that this is not intended to be limiting, and that the system 1200 can include a plurality of processing units and/or non-transitory computer readable media. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system 1200 can occur at one or more of the aforementioned locations.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the invention and that methods and structures within the scope of these claims and their equivalents be covered thereby.

What is claimed is:

1. An unmanned aerial vehicle (UAV) comprising:
one or more propulsion units configured to generate lift to effect flight of the UAV;
one or more receivers configured to receive user input from a remote controller; and
one or more processors configured to: 1) permit the UAV to fly autonomously along a planned trajectory when no user input is received by the one or more receivers and 2) permit the UAV to fly completely based on the user input when the user input is received by the one or more receivers.

2. The UAV of claim 1, wherein the planned trajectory is changed by the user input such that the UAV is permitted to fly autonomously along the changed planned trajectory.

3. The UAV of claim 1, wherein the planned trajectory is a three dimensional flight trajectory.

4. The UAV of claim 1, wherein the one or more processors are further configured to permit the UAV to continue to fly autonomously along the planned trajectory after the user input is executed.

5. The UAV of claim 1, wherein the one or more processors are configured to permit the UAV to deviate from the planned trajectory based on the user input.

6. The UAV of claim 5, wherein the one or more processors are further configured to permit the UAV to deviate from the planned trajectory to avoid one or more obstacles present along the planned trajectory.

7. The UAV of claim 5, wherein the one or more processors are further configured to permit the UAV to autonomously return to the planned trajectory.

8. The UAV of claim 7, wherein the one or more processors are further configured to permit the UAV to autonomously return to the planned trajectory through a progressively smooth flight back along a curved path intersecting with the planned trajectory.

9. The UAV of claim 7, wherein the one or more processors are further configured to permit the UAV to autonomously return to the planned trajectory along a shortest path intersecting with the planned trajectory.

10. The UAV of claim 7, wherein the one or more processors are further configured to permit the UAV to autonomously return to the planned trajectory along a path specified by a user.

11. A method for controlling flight of an unmanned aerial vehicle (UAV) comprising:
effecting a flight of the UAV, with aid of one or more propulsion units, along a planned trajectory;
permitting, with aid of one or more processors, the UAV to: 1) fly autonomously along the planned trajectory when no user input is received by one or more receivers of the UAV, and 2) fly completely based on the user input when the user input is received by the one or more receivers of the UAV.

12. The method of claim 11, wherein the planned trajectory is changed by the user input such that the UAV is permitted to fly autonomously along the changed planned trajectory.

13. The method of claim 11, wherein the planned trajectory is a three dimensional flight trajectory.

14. The method of claim 11, further comprising permitting, with aid of the one or more processors, the UAV to continue to fly autonomously along the planned trajectory after the user input is executed.

15. The method of claim 11, further comprising permitting, with aid of the one or more processors, the UAV to deviate from the planned trajectory based on the user input.

16. The method of claim 15, further comprising permitting, with aid of the one or more processors, the UAV to deviate from the planned trajectory to avoid one or more obstacles present along the planned trajectory.

17. The method of claim 15, further comprising permitting, with aid of the one or more processors, the UAV to autonomously return to the planned trajectory.

18. The method of claim 17, wherein permitting the UAV to autonomously return to the planned trajectory comprises permitting the UAV to autonomously return to the planned trajectory through a progressively smooth flight back along a curved path intersecting the planned trajectory.

19. The method of claim 17, wherein permitting the UAV to autonomously return to the planned trajectory comprises permitting the UAV to autonomously return to the planned trajectory along a shortest path intersecting the planned trajectory.

20. The method of claim 17, wherein permitting the UAV to autonomously return to the planned trajectory comprises permitting the UAV to autonomously return to the planned trajectory along a path specified by a user.
